(19) United States
(12) Patent Application Publication
(10) Pub. No.: US 2025/0301139 A1
(43) Pub. Date: Sep. 25, 2025

(54) V-DMC SIGNALLING IMPROVEMENTS IN DISPLACEMENT SUB-BITSTREAM FOR WAVELET COEFFICIENT INTER PREDICTION WITH FIXED-POINT INVERSE QUANTIZATION

(71) Applicant: QUALCOMM Incorporated, San Diego, CA (US)

(72) Inventors: Geert Van der Auwera, San Diego, CA (US); Adarsh Krishnan Ramasubramonian, Irvine, CA (US); Anique Akhtar, San Diego, CA (US); Reetu Hooda, San Diego, CA (US); Marta Karczewicz, San Diego, CA (US)

(21) Appl. No.: 19/085,875

(22) Filed: Mar. 20, 2025

Related U.S. Application Data
(60) Provisional application No. 63/569,562, filed on Mar. 25, 2024.

(51) Int. Cl. H04N 19/124; H04N 19/33; H04N 19/513

(52) U.S. Cl. CPC H04N 19/124; H04N 19/33; H04N 19/513

(57) ABSTRACT

A device for decoding encoded dynamic mesh data determines a set of quantized integer coefficient values for displacement vectors of the encoded dynamic mesh data; determines a quantization parameter based on one or more syntax elements included in a displacement sub-bitstream of the encoded dynamic mesh data; inverse quantizes, based on the quantization parameter, the set of quantized integer coefficient values to determine a set of fixed-point dequantized coefficient values; determines a set of fixed-point transformed coefficient values based on the set of fixed-point dequantized coefficient values; converts the set of fixed-point transformed coefficient values to a set of floating-point transformed coefficient values; inverse transforms the set of floating-point transformed coefficient values to determine a set of reconstructed displacement vectors; and determines a reconstructed deformed mesh based on the set of reconstructed displacement vectors.

This application claims the benefit of U.S. Provisional Patent Application No. 63/569,562, filed 25 Mar. 2024, the entire contents of which is incorporated herein by reference.

### TECHNICAL FIELD

This disclosure relates to video-based coding of dynamic meshes.

### BACKGROUND

Meshes may be used to represent physical content of a 3-dimensional space. Meshes have utility in a wide variety of situations. For example, meshes may be used in the context of representing the physical content of an environment for purposes of positioning virtual objects in an extended reality, e.g., augmented reality (AR), virtual reality (VR), or mixed reality (MR), application. Mesh compression is a process for encoding and decoding meshes. Encoding meshes may reduce the amount of data required for storage and transmission of the meshes.

### SUMMARY

This disclosure generally relates to video-based coding of dynamic meshes. To determine displacement vectors, a mesh decoder may perform inter prediction on wavelet coefficients after inverse quantization, as described in more detail below. The mesh decoder adds the inverse quantized coefficients (residuals) to inter predicted values that are stored in a frame buffer. A benefit of this technique is that the correlation between wavelet coefficients of adjacent frames is typically greater than the correlation between the corresponding quantized coefficients, which results in additional coding efficiency gains.

To reconstruct the displacement vector wavelet coefficients according to the techniques described herein, the inverse quantization process uses parameters from the bitstream, such as displacement vector dimension, quantization parameters (QP), number of levels of detail (LoDs), number of vertices per LoD, among others. In V-DMC some of these parameters are signaled as part of the atlas metadata sub-bitstream. However, the arithmetic-coded (AC) displacement sub-bitstream does not contain the parameters that the inverse quantization process requires for reconstructing the displacement vector wavelet coefficients from this sub-bitstream without relying on the atlas metadata sub-bitstream. By determining a quantization parameter based on one or more syntax elements included in a displacement sub-bitstream of the encoded dynamic mesh data, the techniques of this disclosure may enable self-contained reconstruction of the displacement vectors without reliance on other sub-bitstreams.

According to an example of this disclosure, a device for decoding encoded dynamic mesh data includes one or more memories and one or more processors, implemented in circuitry and in communication with the one or more memories, configured to determine a set of quantized integer coefficient values for displacement vectors of the encoded dynamic mesh data; determine a quantization parameter based on one or more syntax elements included in a displacement sub-bitstream of the encoded dynamic mesh data; inverse quantize, based on the quantization parameter, the set of quantized integer coefficient values to determine a set of fixed-point dequantized coefficient values; determine a set of fixed-point transformed coefficient values based on the set of fixed-point dequantized coefficient values; convert the set of fixed-point transformed coefficient values to a set of floating-point transformed coefficient values; inverse transform the set of floating-point transformed coefficient values to determine a set of reconstructed displacement vectors; and determine a reconstructed deformed mesh based on the set of reconstructed displacement vectors.

According to another example of this disclosure, a method for decoding encoded dynamic mesh data includes determining a set of quantized integer coefficient values for displacement vectors of the encoded dynamic mesh data; determining a quantization parameter based on one or more syntax elements included in a displacement sub-bitstream of the encoded dynamic mesh data; inverse quantizing, based on the quantization parameter, the set of quantized integer coefficient values to determine a set of fixed-point dequantized coefficient values; determining a set of fixed-point transformed coefficient values based on the set of fixed-point dequantized coefficient values; converting the set of fixed-point transformed coefficient values to a set of floating-point transformed coefficient values; inverse transforming the set of floating-point transformed coefficient values to determine a set of reconstructed displacement vectors; and determining a reconstructed deformed mesh based on the set of reconstructed displacement vectors.

According to another example of this disclosure, a device for encoding dynamic mesh data includes one or more memories and one or more processors, implemented in circuitry and in communication with the one or more memories, configured to: determine a set of integer coefficient values for displacement vectors of the encoded dynamic mesh data; determine a quantization parameter; quantize, based on the quantization parameter, the set of integer coefficient values to determine a set of quantized coefficient values; and include, in a displacement sub-bitstream of the encoded dynamic mesh data, one or more syntax elements indicating the quantization parameter.

According to another example of this disclosure, a method for encoding dynamic mesh data includes determining a set of integer coefficient values for displacement vectors of the encoded dynamic mesh data; determining a quantization parameter; quantizing, based on the quantization parameter, the set of integer coefficient values to determine a set of quantized coefficient values; and including, in a displacement sub-bitstream of the encoded dynamic mesh data, one or more syntax elements indicating the quantization parameter.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 shows an example implementation of a video-based dynamic mesh coding (V-DMC) encoder.

FIGS. 3 and 4 show example implementations of V-DMC decoders.

FIG. 5 shows an example of resampling to enable efficient compression of a 2D curve.

FIG. 6 shows a displaced curve that has a subdivision structure, while approximating the shape of the original mesh.

FIG. 7 shows a block diagram of a pre-processing system.

FIG. 8 shows an example implementation of an intra-mode encoder for V-DMC.

FIG. 9 shows an example implementation of an intra-mode decoder for V-DMC.

FIG. 10 show an example of a displacement decoder.

FIG. 11 illustrates a subdivision process.

FIG. 12 show an example of a displacement decoder process.

FIG. 13A shows an example of a floating-point displacement decoder.

FIG. 13B shows an example of a fixed-point displacement decoder.

FIG. 14A shows an example of a floating-point displacement decoder.

FIG. 14B shows an example of a fixed-point displacement decoder.

FIG. 15 is a flowchart illustrating an example process for encoding a mesh.

FIG. 16 is a flowchart illustrating an example process for decoding a compressed bitstream of mesh data.

FIG. 17 is a flowchart illustrating an example process for decoding a compressed bitstream of mesh data.

### DETAILED DESCRIPTION

A mesh generally refers to a collection of vertices in a three-dimensional (3D) space that collectively represent one or multiple objects in the 3D space. The vertices are connected by edges, and the edges form polygons, which form faces of the mesh. Each vertex may also have one or more associated attributes, such as a texture or a color. In most scenarios, having more vertices produces higher quality, e.g., more detailed and more realistic, meshes. Having more vertices, however, also requires more data to represent the mesh.

To reduce the amount of data needed to represent the mesh, the mesh may be encoded using lossy or lossless encoding. In lossless encoding, the decoded version of the encoded mesh exactly matches the original mesh. In lossy encoding, by contrast, the process of encoding and decoding the mesh causes loss, such as distortion, in the decoded version of the encoded mesh.

In one example of a lossy encoding technique for meshes, a mesh encoder decimates an original mesh to determine a base mesh. To decimate the original mesh, the mesh encoder subsamples or otherwise reduces the number of vertices in the original mesh, such that the base mesh is a rough approximation, with fewer vertices, of the original mesh. The mesh encoder then subdivides the decimated mesh. That is the mesh encoder estimates the locations of additional vertices in between the vertices of the base mesh. The mesh encoder then deforms the subdivided mesh by moving the vertices in a manner that makes the deformed mesh more closely match the original mesh.

After determining a desired base mesh and deformation of the subdivided mesh, the mesh encoder generates a bitstream that includes data for constructing the base mesh and data for performing the deformation. The data defining the deformation may be signaled as a series of displacement vectors that indicate the movement, or displacement, of the additional vertices determined by the subdividing process. To decode a mesh from the bitstream, a mesh decoder reconstructs the base mesh based on the signaled information, applies the same subdivision process as the mesh encoder, and then displaces the additional vertices based on the signaled displacement vectors.

This disclosure relates to encoding and decoding base mesh data. More specifically, this disclosure describes various improvements to displacement vector inter prediction processes in the V-DMC technology, which is being standardized in MPEG WG7 (3DGH). This disclosure describes techniques for implementing a fixed-point (integer) quantization process in an inter prediction process for displacement vector coding.

To determine displacement vectors, a mesh decoder may perform inter prediction on wavelet coefficients after inverse quantization, as described in more detail below. The mesh decoder adds the inverse quantized coefficients (residuals) to inter predicted values that are stored in a frame buffer. A benefit of this technique is that the correlation between wavelet coefficients of adjacent frames is typically greater than the correlation between the corresponding quantized coefficients, which results in additional coding efficiency gains.

To reconstruct the displacement vector wavelet coefficients according to the techniques described herein, the inverse quantization process uses parameters from the bitstream, such as displacement vector dimension, quantization parameters (QP), number of levels of detail (LoDs), number of vertices per LoD, among others. In V-DMC some of these parameters are signaled as part of the atlas metadata sub-bitstream. However, the arithmetic-coded (AC) displacement sub-bitstream does not contain the parameters that the inverse quantization process requires for reconstructing the displacement vector wavelet coefficients from this sub-bitstream without relying on the atlas metadata sub-bitstream. By determining a quantization parameter based on one or more syntax elements included in a displacement sub-bitstream of the encoded dynamic mesh data, the techniques of this disclosure may enable self-contained reconstruction of the displacement vectors without reliance on other sub-bitstreams.

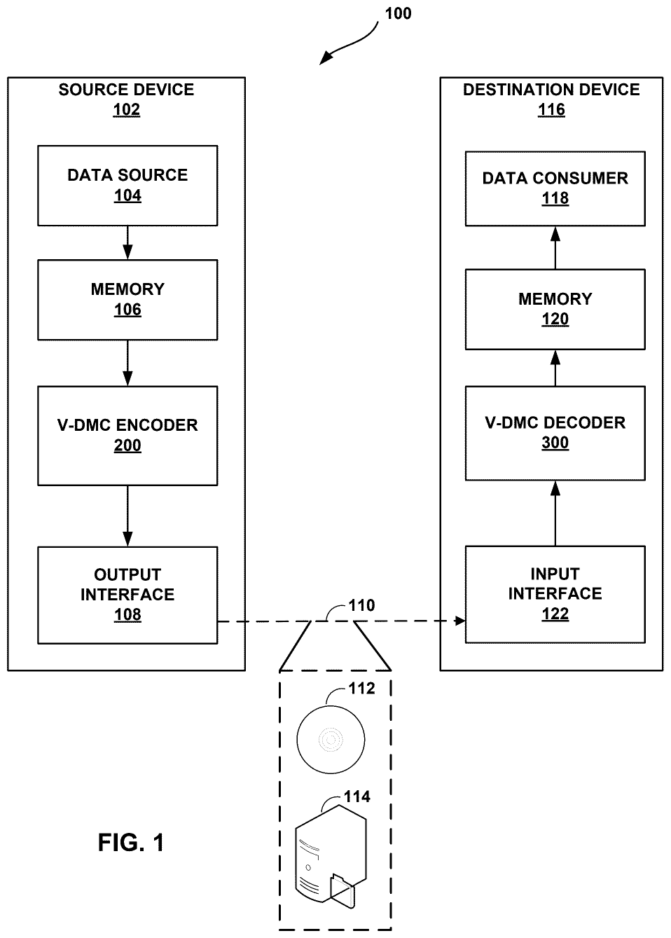

FIG. 1 is a block diagram illustrating an example encoding and decoding system 100 that may perform the techniques of this disclosure. The techniques of this disclosure are generally directed to coding (encoding and/or decoding) meshes. The coding may be effective in compressing and/or decompressing data of the meshes.

As shown in FIG. 1, system 100 includes a source device 102 and a destination device 116. Source device 102 provides encoded data to be decoded by a destination device 116. Particularly, in the example of FIG. 1, source device 102 provides the data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a V-DMC encoder 200, and an output interface 108. Destination device 116 includes an input interface 122, a V-DMC decoder 300, a memory 120, and a data consumer 118. In accordance with this disclosure, V-DMC encoder 200 of source device 102 and V-DMC decoder 300 of destination device 116 may be configured to apply the techniques of this disclosure related to displacement vector quantization. Thus, source device 102 represents an example of an encoding device, while destination device 116 represents an example of a decoding device. In other examples, source device 102 and destination device 116 may include other components or arrangements. For example, source device 102 may receive data from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to displacement vector quantization. Source device 102 and destination device 116 are merely examples of such devices in which source device 102 generates coded data for transmission to destination device 116. This disclosure refers to a “coding” device as a device that performs coding (encoding and/or decoding) of data. Thus, V-DMC encoder 200 and V-DMC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (i.e., raw, unencoded data) and may provide a sequential series of “frames”) of the data to V-DMC encoder 200, which encodes data for the frames. Data source 104 of source device 102 may include a mesh capture device, such as any of a variety of cameras or sensors, e.g., a 3D scanner or a light detection and ranging (LIDAR) device, one or more video cameras, an archive containing previously captured data, and/or a data feed interface to receive data from a data content provider. Alternatively or additionally, mesh data may be computer-generated from scanner, camera, sensor or other data. For example, data source 104 may generate computer graphics-based data as the source data, or produce a combination of live data, archived data, and computer-generated data. In each case, V-DMC encoder 200 encodes the captured, pre-captured, or computer-generated data. V-DMC encoder 200 may rearrange the frames from the received order (sometimes referred to as “display order”) into a coding order for coding. V-DMC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from V-DMC decoder 300. Additionally or alternatively, memory 106 and memory 120 may store software instructions executable by, e.g., V-DMC encoder 200 and V-DMC decoder 300, respectively. Although memory 106 and memory 120 are shown separately from V-DMC encoder 200 and V-DMC decoder 300 in this example, it should be understood that V-DMC encoder 200 and V-DMC decoder 300 may also include internal memories for functionally similar or equivalent purposes. Furthermore, memory 106 and memory 120 may store encoded data, e.g., output from V-DMC encoder 200 and input to V-DMC decoder 300. In some examples, portions of memory 106 and memory 120 may be allocated as one or more buffers, e.g., to store raw, decoded, and/or encoded data. For instance, memory 106 and memory 120 may store data representing a mesh.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to V-DMC encoder 200 and/or output interface 108, and destination device 116 may include an SoC device to perform the functionality attributed to V-DMC decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by V-DMC encoder 200, which is also used by V-DMC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on meshes.

V-DMC encoder 200 and V-DMC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of V-DMC encoder 200 and V-DMC decoder 300 may be included in one or more encoders or decoders, either of which may be integrated as part of a combined encoder/decoder (CODEC) in a respective device. A device including V-DMC encoder 200 and/or V-DMC decoder 300 may comprise one or more integrated circuits, microprocessors, and/or other types of devices.

V-DMC encoder 200 and V-DMC decoder 300 may operate according to a coding standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, V-DMC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

This disclosure describes techniques that may provide various improvements in the vertex attribute encoding for base meshes in the video-based coding of dynamic meshes (V-DMC), which is being standardized in MPEG WG7 (3DGH). In V-DMC, the base mesh connectivity is encoded using an edgebreaker implementation, and the base mesh attributes can be encoded using residual encoding with attribute prediction. This disclosure describes techniques to implement a transform and/or quantization on the attribute and/or the predictions and/or the residuals for the base mesh encoding, which may improve the coding performance of the base mesh encoding.

Working Group 7 (WG7), often referred to as the 3D Graphics and Haptics Coding Group (3DGH), is presently engaged in standardizing the video-based dynamic mesh coding (V-DMC) for XR applications. The current testing model includes preprocessing input meshes into simplified versions called “base meshes.” These base meshes, often contain fewer vertices than the original mesh, are encoded using a base mesh coder also called a static mesh coder. The preprocessing also generates displacement vectors as well as a texture attribute map that are both encoded using a video encoder. If the mesh is encoded in a lossless manner, then the base mesh is no longer a simplified version and is used to encode the original mesh.

The base mesh encoder encodes the connectivity of the mesh as well as the attributes associated with each vertex which typically involves the position and a coordinate for the texture but are not limited to these attributes. The position includes 3D coordinates (x,y,z) of the vertex while, the texture is stored as a 2D UV coordinate (u,v) that points to a texture map image pixel location. The base mesh in V-DMC is encoded using an edgebreaker algorithm, while the connectivity is encoded using a CLERS op code. The residual of the attribute is encoded using prediction from the previously encoded/decoded vertices. Other types of static mesh coders, such as Google Draco, may also be used. Other types of coding may also be used for the connectivity coding and residual coding.

The edgebreaker algorithm is described in Jean-Eudes Marvie, Olivier Mocquard, [V-DMC][EE4.4] An efficient Edgebreaker implementation is described in ISO/IEC JTC1/SC29/WG7, m63344, April 2023 (hereinafter “m63344”). The CLERS op code is described in J. Rossignac, “3D compression made simple: Edgebreaker with ZipandWrap on a corner-table,” in Proceedings International Conference on Shape Modeling and Applications, Genova, Italy, 2001 (hereinafter “Rossignac”) and H. Lopes, G. Tavares, J. Rossignac, A. Szymczak and A. Safonova, “Edgebreaker: a simple compression for surfaces with handles.” in ACM Symposium on Solid Modeling and Applications, Saarbrucken, 2002 (hereinafter “Lopes”).

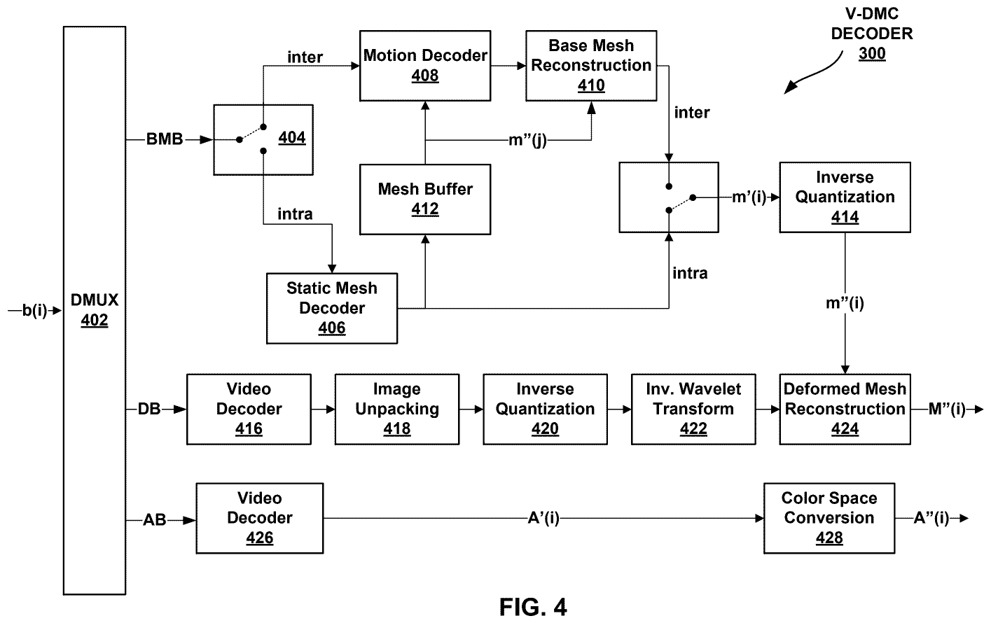

Additionaly, V-DMC encoder 200 may estimate the motion of the base mesh vertices and code the motion vectors into the bitstream. The reconstructed base meshes may be subdivided into finer meshes with additional vertices and, hence, additional triangles. V-DMC encoder 200 may refine the positions of the subdivided mesh vertices to approximate the original mesh. The refinements or vertex displacement vectors may be coded into the bitstream. In the current test model, the displacement vectors are wavelet transformed (lifting process), quantized, and the coefficients are either packed into a 2D frame or directly coded with an arithmetic coder after inter prediction. The sequence of video frames is coded with a typical video coder, for example, High Efficiency Video Coding (HEVC) Standard or the Versatile Video Coding (VVC) standard, into the bitstream. In addition, the sequence of texture frames is coded with a video coder. The simplified architecture of the V-DMC decoder is illustrated in FIG. 4.

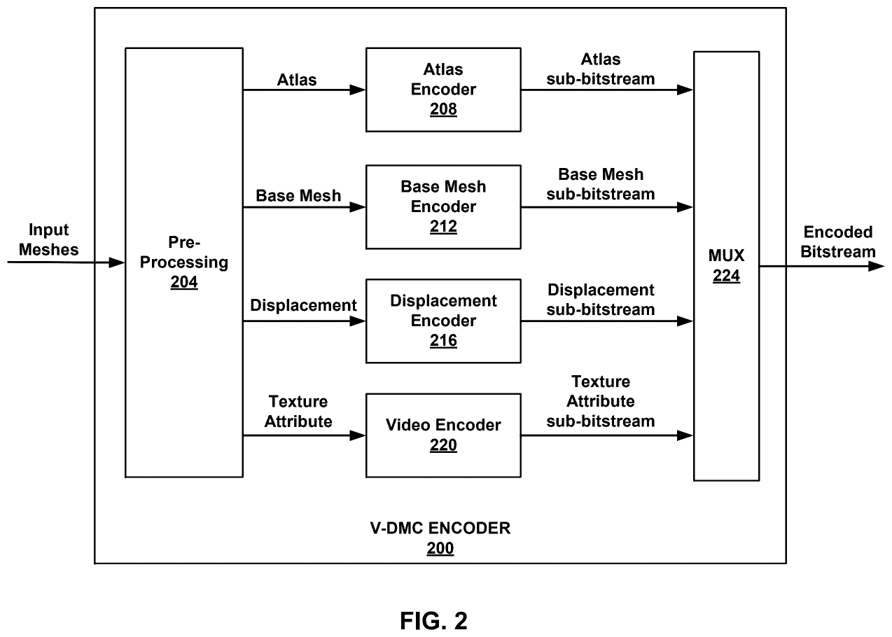

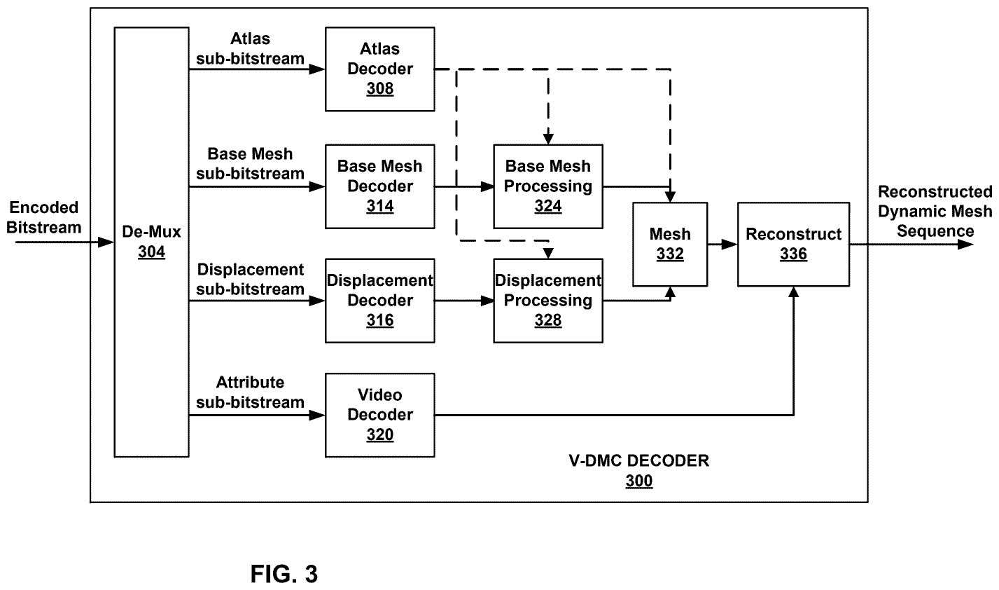

FIGS. 2 and 3 show the overall system model for the current V-DMC test model (TM) encoder (V-DM encoder 200 in FIG. 2) and decoder (V-DMC decoder 300 in FIG. 3) architecture. V-DMC encoder 200 performs volumetric media conversion, and V-DMC decoder 300 performs a corresponding reconstruction. The 3D media is converted to a series of sub-bitstreams: base mesh, displacement, and texture attributes. Additional atlas information is also included in the bitstream to enable inverse reconstruction, as described in N00680.

FIG. 2 shows an example implementation of V-DMC encoder 200. In the example of FIG. 2, V-DMC encoder 200 includes pre-processing unit 204, atlas encoder 208, base mesh encoder 212, displacement encoder 216, and video encoder 220. Pre-processing unit 204 receives an input mesh sequence and generates a base mesh, the displacement vectors, and the texture attribute maps. Base mesh encoder 212 encodes the base mesh. Displacement encoder 216 encodes the displacement vectors, for example as V3C video components or using arithmetic displacement coding. Video encoder 220 encodes the texture attribute components, e.g., texture or material information, using any video codec, such as HEVC or VVC.

Aspects of V-DMC encoder 200 will now be described in more detail. Pre-processing unit 204 represents the 3D volumetric data as a set of base meshes and corresponding refinement components. This is achieved through a conversion of input dynamic mesh representations into a number of V3C components: a base mesh, a set of displacements, a 2D representation of the texture map, and an atlas. The base mesh component is a simplified low-resolution approximation of the original mesh in the lossy compression and is the original mesh in the lossless compression. The base mesh component can be encoded by base mesh encoder 212 using any mesh codec.

Base mesh encoder 212 may, for example, employ an implementation of the Edgebreaker algorithm, e.g., m63344, for encoding the base mesh where the connectivity is encoded using a CLERS op code, e.g., from Rossignac and Lopes, and the residual of the attribute is encoded using prediction from the previously encoded/decoded vertices' attributes.

Aspects of base mesh encoder 212 will now be described in more detail. One or more submeshes are input to base mesh encoder 212. Submeshes are generated by pre-processing unit 204. Submeshes are generated from original meshes by utilizing semantic segmentation. Each base mesh may include of one or more submeshes.

Base mesh encoder 212 may process connected components. Connected components include of a cluster of triangles that are connected by their neighbors. A submesh can have one or more connected components. Base mesh encoder 212 may encode one “connected component” at a time for connectivity and attributes encoding and then performs entropy encoding on all “connected components”.

FIG. 3 shows an example implementation of V-DMC decoder 300. In the example of FIG. 3, V-DMC decoder 300 includes demultiplexer 304, atlas decoder 308, base mesh decoder 314, displacement decoder 316, video decoder 320, base mesh processing unit 324, displacement processing unit 328, mesh generation unit 332, and reconstruction unit 336.

Demultiplexer 304 separates the encoded bitstream into an atlas sub-bitstream, a base-mesh sub-bitstream, a displacement sub-bitstream, and a texture attribute sub-bitstream. Atlas decoder 308 decodes the atlas sub-bitstream to determine the atlas information to enable inverse reconstruction. Base mesh decoder 314 decodes the base mesh sub-bitstream, and base mesh processing unit 324 reconstructs the base mesh. Displacement decoder 316 decodes the displacement sub-bitstream, and displacement processing unit 328 reconstructs the displacement vectors. Mesh generation unit 332 modifies the base mesh based on the displacement vector to form a displaced mesh.

Video decoder 320 decodes the texture attribute sub-bitstream to determine the texture attribute map, and reconstruction unit 336 associates the texture attributes with the displaced mesh to form a reconstructed dynamic mesh.

A more detailed description of the proposal that was selected as the starting point for the V-DMC standardization will now be described. The following description details the displacement vector coding in the current V-DMC test model and working draft, WD 5.0 of V-DMC, ISO/IEC JTC1/SC29/WG7, N00744, October 2023.

FIG. 4 shows an example implementation V-DMC decoder 300, which may be configured to perform the decoding process as set forth in WD 2.0 of V-DMC, ISO/IEC JTC1/SC29/WG7, N00546, January 2023. The processes described with respect to FIG. 2 may also be performed, in full or in part, by V-DMC encoder 200.

V-DMC decoder 300 includes demultiplexer (DMUX) 402, which receives compressed bitstream b(i) and separates the compressed bitstream into a base mesh bitstream (BMB), a displacement bitstream (DB), and an attribute bitstream (AB). Mode select unit 404 determines if the base mesh data is encoded in an intra mode or an inter mode. If the base mesh is encoded in an intra mode, then static mesh decoder 406 decodes the mesh data without reliance on any previously decoded meshes. If the base mesh is encoded in an inter mode, then motion decoder 408 decodes motion, and base mesh reconstruction unit 410 applies the motion to an already decoded mesh stored in mesh buffer 412 to determine a reconstructed quantized base mesh (m′(i))). Inverse quantization unit 414 applies an inverse quantization to the reconstructed quantized base mesh to determine a reconstructed base mesh (m″(i)).

Video decoder 416 decodes the displacement bitstream to determine a set or frame of quantized transform coefficients. For purposes of encoding and decoding, quantized transform coefficients can be considered to be in a two-dimensional structure, e.g., a frame. Image unpacking unit 418 unpacks, e.g., serializes, the quantized transform coefficients from the frame. Inverse quantization unit 420 inverse quantizes, e.g., inverse scales, quantized transform coefficients to determine de-quantized transform coefficients. Inverse wavelet transform unit 422 applies an inverse transform to the de-quantized transform coefficients to determine a set of displacement vectors. Deformed mesh reconstruction unit 424 deforms the reconstructed base mesh using the decoded displacement vectors to determine a decoded mesh (M″(i)).

Video decoder 426 decodes the attribute bitstream to determine decoded attribute values (A′(i)), and color space conversion unit 428 converts the decoded attribute values into a desired color space to determine final attribute values (A″(i)). The final attribute values correspond to attributes, such as color or texture, for the vertices of the decoded mesh.

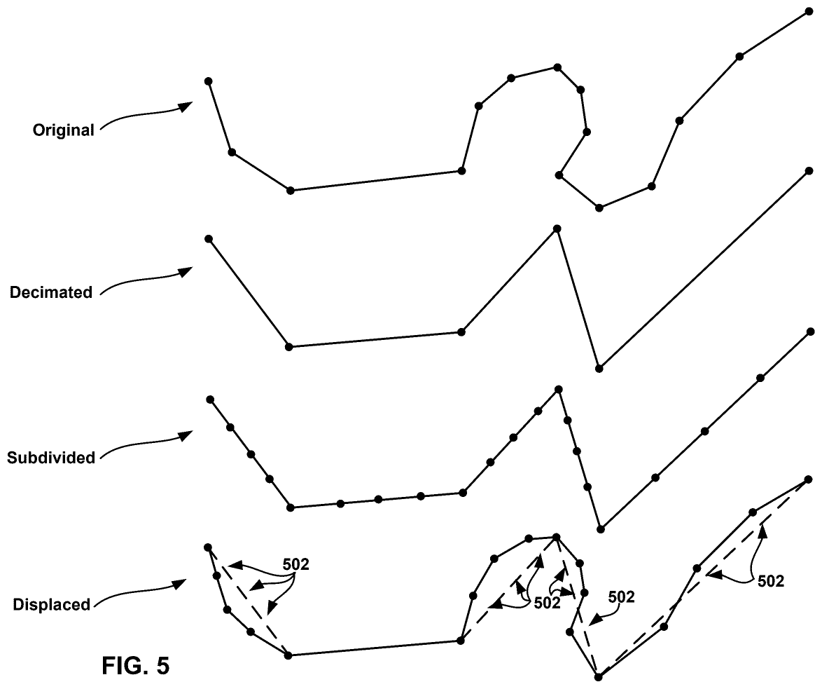

FIG. 5 illustrates the basic idea behind the proposed pre-processing by using a 2D curve. The same concepts are applied to the input 3D mesh M(i) to produce a base mesh m(i) and a displacement field d(i).

In FIG. 5, the input 2D curve (represented by a 2D polyline), referred to as the “original” curve, is first downsampled to generate a base curve/polyline, referred to as the “decimated” curve. A subdivision process, such as that described in Garland et al, Surface Simplification Using Quadric Error Metrics (https://www.cs.cmu.edu/˜garland/Papers/quadrics.pdf), is then applied to the decimated polyline to generate a “subdivided” curve. For instance, in FIG. 5, a subdivision process using an iterative interpolation process is applied. The process includes inserting at each iteration a new point in the middle of each edge of the polyline. In the example illustrated, two subdivision iterations are applied.

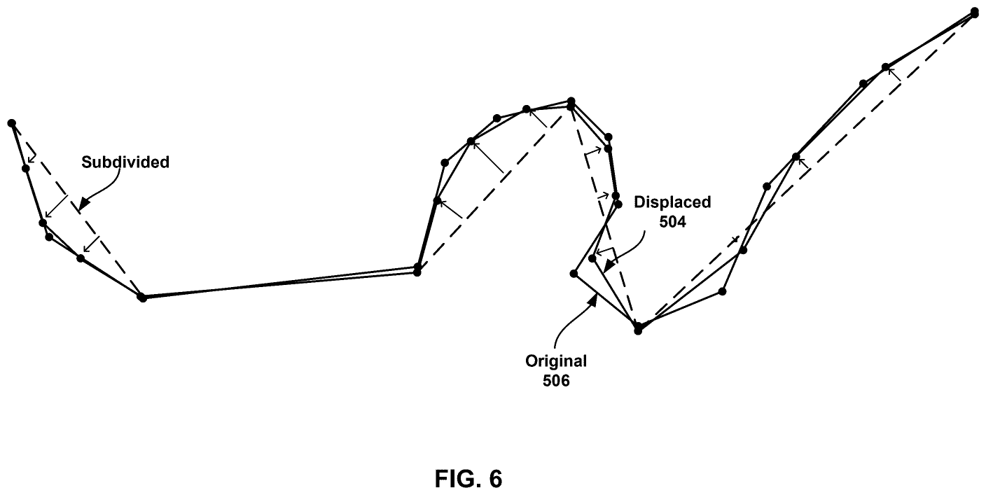

The proposed process is independent of the chosen subdivision process and may be combined with other subdivision process. The subdivided polyline is then deformed to get a better approximation of the original curve. A displacement vector is computed for each vertex of the subdivided mesh (arrows 502 in FIG. 5) such that the shape of the displaced curve is as close as possible to the shape of the original curve (see FIG. 6). As illustrated by portion 504 of the displaced curve and portion 506 of the original curve, for example, the displaced curve may not perfectly match the original curve.

An advantage of the subdivided curve is that the subdivided curve has a subdivision structure that allows efficient compression, while offering a faithful approximation of the original curve. The compression efficiency is obtained based on:
The decimated/base curve has a low number of vertices and requires a limited number of bits to be encoded/transmitted.
The subdivided curve is automatically generated by the decoder once the base/decimated curve is decoded(i.e., no need for any information other than the subdivision process type and subdivision iteration count).
The displaced curve is generated by decoding the displacement vectors associated with the subdivided curve vertices. Besides allowing for spatial/quality scalability, the subdivision structure enables efficient transforms such as wavelet decomposition, which can offer high compression performance.

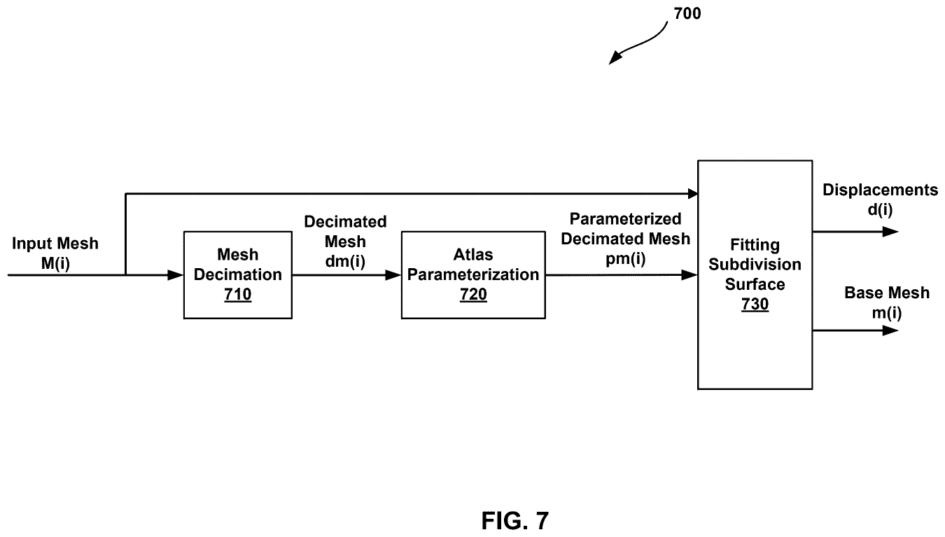

FIG. 7 shows a block diagram of pre-processing system 700 which may be included in V-DMC encoder 200. In the example of FIG. 7, pre-processing system 700 includes mesh decimation unit 710, atlas parameterization unit 720, and subdivision surface fitting unit 730.

Mesh decimation unit 710 uses a simplification technique to decimate the input mesh M(i) and produce the decimated mesh dm(i). The decimated mesh dm(i) is then re-parameterized by atlas parameterization unit 720, which may for example use the UVAtlas tool. The generated mesh is denoted as pm(i). The UVAtlas tool considers only the geometry information of the decimated mesh dm(i) when computing the atlas parameterization, which is likely sub-optimal for compression purposes. Other parameterization processes or tools may also be used with the proposed framework.

Applying re-parameterization to the input mesh makes it possible to generate a lower number of patches. This reduces parameterization discontinuities and may lead to better RD (rate-distortion) performance. Subdivision surface fitting unit 730 takes as input the re-parameterized mesh pm(i) and the input mesh M(i) and produces the base mesh m(i) together with a set of displacements d(i). First, pm(i) is subdivided by applying the subdivision process. The displacement field d(i) is computed by determining for each vertex of the subdivided mesh the nearest point on the surface of the original mesh M(i).

For the Random Access (RA) condition, a temporally consistent re-meshing may be computed by considering the base mesh m(j) of a reference frame with index j as the input for subdivision surface fitting unit 730. This makes it possible to produce the same subdivision structure for the current mesh M′(i) as the one computed for the reference mesh M′(j). Such a re-meshing process makes it possible to skip the encoding of the base mesh m(i) and re-use the base mesh m(j) associated with the reference frame M(j). This may also enable better temporal prediction for both the attribute and geometry information. For example, a motion field f(i) describing how to move the vertices of m(j) to match the positions of m(i) is computed and encoded. Such time-consistent re-meshing may not always possible. The techniques of this disclosure may also include comparing the distortion obtained with and without the temporal consistency constraint and chooses the mode that offers the best RD compromise.

Note that the pre-processing system is not normative and may be replaced by any other system that produces displaced subdivision surfaces. A possible efficient implementation would constrain the 3D reconstruction unit to directly generate displaced subdivision surface and avoids the need for such pre-processing.

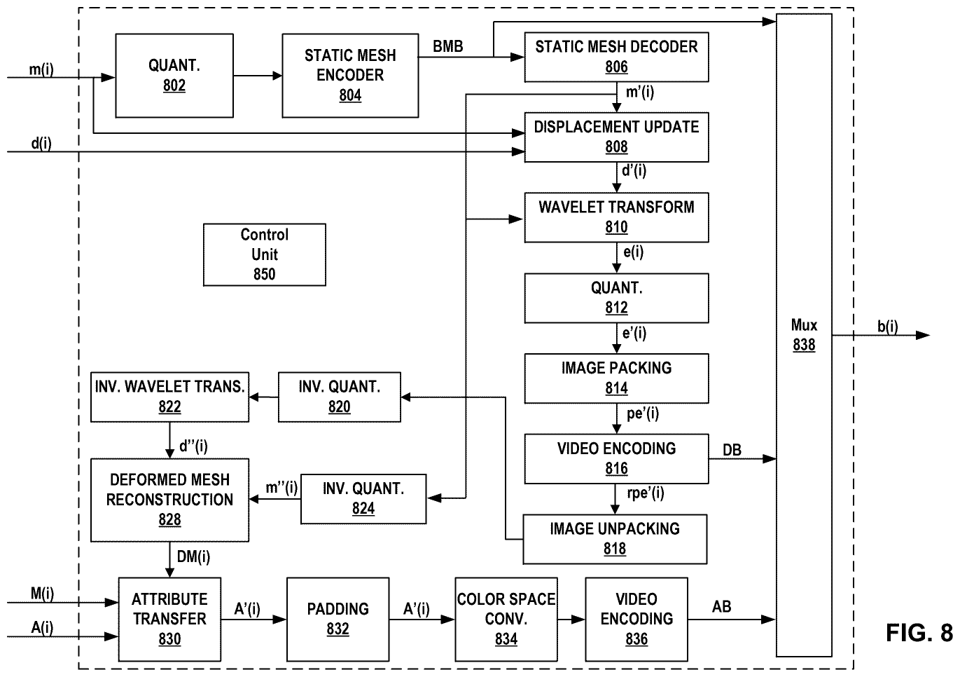

V-DMC encoder 200 and V-DMC decoder 300 may be configured to perform displacements coding. Depending on the application and the targeted bitrate/visual quality, the V-DMC encoder 200 may optionally encode a set of displacement vectors associated with the subdivided mesh vertices, referred to herein as the displacement field d(i). The intra encoding process, which may be performed by V-DMC encoder 200, is illustrated in FIG. 8.

FIG. 8 includes the following abbreviations:
m(i)—Base mesh
d(i)—Displacements
m″(i)—Reconstructed Base Mesh
d″(i)—Reconstructed Displacements
A(i)—Attribute Map
A′(i)—Updated Attribute Map
M(i)—Static/Dynamic Mesh
DM(i)—Reconstructed Deformed Mesh
m′(i)—Reconstructed Quantized Base Mesh
d′(i)—Updated Displacements
e(i)—Wavelet Coefficients
e′(i)—Quantized Wavelet Coefficients
pe′(i)—Packed Quantized Wavelet Coefficients
rpe′(i)—Reconstructed Packed Quantized Wavelet Coefficients
AB—Compressed attribute bitstream
DB—Compressed displacement bitstream
BMB—Compressed base mesh bitstream
b(i)—Compressed bitstream

V-DMC encoder 200 receives base mesh m(i) and displacements d(i), for example from pre-processing system 700 of FIG. 7. V-DMC encoder 200 also retrieves mesh M(i) and attribute map A (i).

Quantization unit 802 quantizes the base mesh, and static mesh encoder 804 encodes the quantized based mesh to generate a compressed base mesh bitstream (BMB).

Displacement update unit 808 uses the reconstructed quantized base mesh m′(i) to update the displacement field d(i) to generate an updated displacement field d′(i). This process considers the differences between the reconstructed base mesh m′(i) and the original base mesh m(i). By exploiting the subdivision surface mesh structure, wavelet transform unit 810 applies a wavelet transform to d′(i) to generate a set of wavelet coefficients (e(i)). The process is agnostic of the transform applied and may leverage any other transform, including the identity transform. Quantization unit 812 quantizes wavelet coefficients, and image packing unit 814 packs the quantized wavelet coefficients into a 2D image/video that can be compressed using a traditional image/video encoder (e.g., such as using techniques similar to VVC) to generate a displacement bitstream.

Attribute transfer unit 830 converts the original attribute map A (i) to an updated attribute map that corresponds to the reconstructed deformed mesh DM(i). Padding unit 832 pads the updated attributed map by, for example, filling patches of the frame that have empty samples with interpolated samples that may improve coding efficiency and reduce artifacts. Color space conversion unit 834 converts the attribute map into a different color space, and video encoding unit 836 encodes the updated attribute map in the new color space, using for example a video codec, to generate an attribute bitstream.

Multiplexer 838 combines the compressed attribute bitstream, compressed displacement bitstream, and compressed base mesh bitstream into a single compressed bitstream (b(i)).

Image unpacking unit 818 and inverse quantization unit 820 apply image unpacking and inverse quantization to the reconstructed packed quantized wavelet coefficients generated by video encoding unit 816 to obtain the reconstructed version of the wavelet coefficients. Inverse wavelet transform unit 822 applies and inverse wavelet transform to the reconstructed wavelet coefficient to determine reconstructed displacements d″(i).

Inverse quantization unit 824 applies an inverse quantization to the reconstructed quantized base mesh m′(i) to obtain a reconstructed base mesh m″(i). Deformed mesh reconstruction unit 828 subdivides m″(i) and applies the reconstructed displacements d″(i) to its vertices to obtain the reconstructed deformed mesh DM(i).

Image unpacking unit 818, inverse quantization unit 820, inverse wavelet transform unit 822, and deformed mesh reconstruction unit 828 represent a displacement decoding loop. Inverse quantization unit 824 and deformed mesh reconstruction unit 828 represent a base mesh decoding loop. Mesh encoder 800 includes the displacement decoding loop and the base mesh decoding loop so that mesh encoder 800 can make encoding decisions, such as determining an acceptable rate-distortion tradeoff, based on the same decoded mesh that a mesh decoder will generate, which may include distortion due to the quantization and transforms. Mesh encoder 800 may also use decoded versions of the base mesh, reconstructed mesh, and displacements for encoding subsequent base meshes and displacements.

Control unit 850 generally represents the decision making functionality of V-DMC encoder 200. During an encoding process, control unit 850 may, for example, make determinations with respect to mode selection, rate allocation, quality control, and other such decisions.

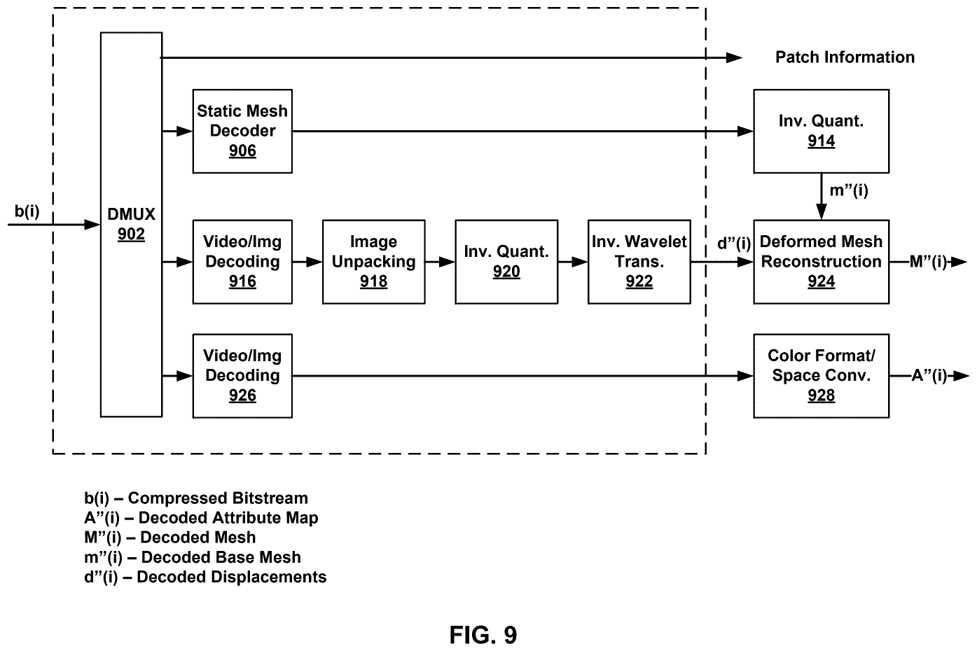

FIG. 9 shows a block diagram of an intra decoder which may, for example, be part of V-DMC decoder 300. De-multiplexer (DMUX) 902 separates compressed bitstream (b(i)) into a mesh sub-stream, a displacement sub-stream for positions and potentially for each vertex attribute, zero or more attribute map sub-streams, and an atlas sub-stream containing patch information in the same manner as in V3C/V-PCC.

De-multiplexer 902 feeds the mesh sub-stream to static mesh decoder 906 to generate the reconstructed quantized base mesh m′(i). Inverse quantization unit 914 inverse quantizes the base mesh to determine the decoded base mesh m″(i). Video/image decoding unit 916 decodes the displacement sub-stream, and image unpacking unit 918 unpacks the image/video to determine quantized transform coefficients, e.g., wavelet coefficients. Inverse quantization unit 920 inverse quantizes the quantized transform coefficients to determine dequantized transform coefficients. Inverse transform unit 922 generates the decoded displacement field d″(i) by applying the inverse transform to the unquantized coefficients. Deformed mesh reconstruction unit 924 generates the final decoded mesh (M″(i)) by applying the reconstruction process to the decoded base mesh m″(i) and by adding the decoded displacement field d″(i). The attribute sub-stream is directly decoded by video/image decoding unit 926 to generate an attribute map A″(i). Color format/space conversion unit 928 may convert the attribute map into a different format or color space.

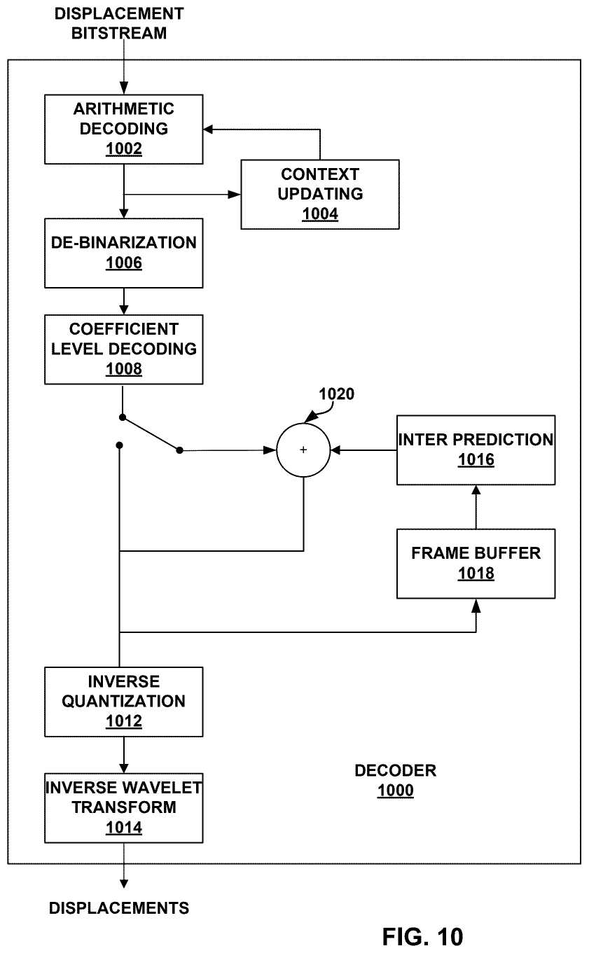

As an addition or alternative to packing the quantized wavelet coefficients in frames and coding as images or video, a process that directly codes the quantized wavelet coefficients with a block-based arithmetic coder may also be used. This process is illustrated in FIG. 10. The decoded quantized wavelet coefficients are inter predicted from the reference buffer, which contains quantized wavelet coefficients from prior frames, for example, the preceding frame. In the example of FIG. 10, decoder 1000 performs context-based arithmetic decoding 1002 of a displacement bitstream based on a context update 1004. Decoder 1000 performs de-binarization 1006 on the context decoded bitstream to determine values for syntax elements and performs coefficient level decoding 1008 on the syntax elements. For intra coded displacements, decoder 1000 performs inverse quantization 1012 on the coefficient levels to determine de-quantized coefficient levels, and then performs an inverse wavelet transform 1014 on the de-quantized coefficient levels to determine the displacements. For inter coded displacements, decoder 1000 performs inter prediction 1016 using reference frames stored in a frame buffer 1018 and adds 1020 the prediction values to the coefficient levels to determine final coefficient levels. Decoder 1000 then performs inverse quantization 1012 on the final coefficient levels to determine de-quantized coefficient levels, and then performs an inverse wavelet transform 1014 on the de-quantized coefficient levels to determine the displacements.

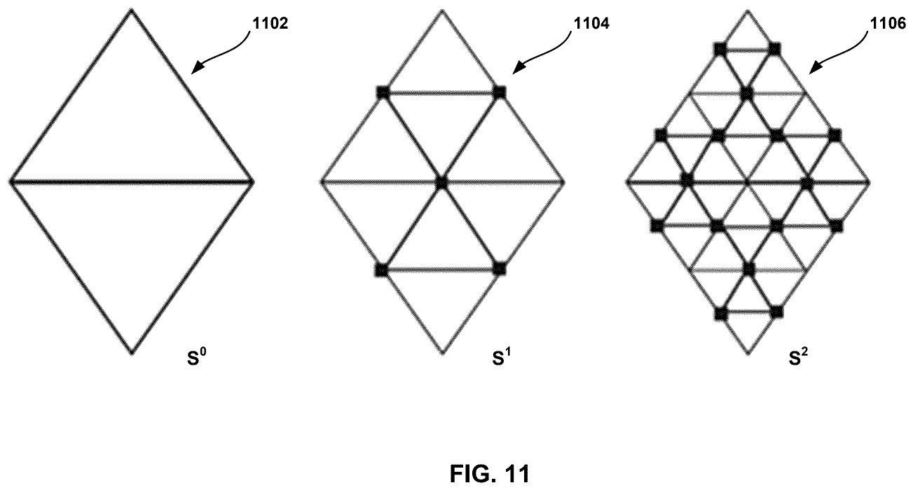

V-DMC encoder 200 and V-DMC decoder 300 may be configured to implement a subdivision process. Various subdivision processes could be considered. A possible solution is the mid-point subdivision process, which at each subdivision iteration subdivides each triangle into four sub-triangles as described in FIG. 11. New vertices are introduced in the middle of each edge. In the example, FIG. 11, triangles 1102 are subdivided to obtain triangles 1104, and triangles 1104 are subdivided to obtain triangles 1106. The subdivision process is applied independently to the geometry and to the texture coordinates since the connectivity for the geometry and for the texture coordinates is usually different. The sub-division process computes the position Pos(ν₁₂) of a newly introduced vertex ν₁₂ at the center of an edge (ν₁, ν₂), as follows:

$$Pos ( {v}_{12} ) = \frac{1}{2} ( Pos ( {v}_{1} ) + Pos ( {v}_{2} ) ) ,$$

where Pos(ν₁) and Pos(ν₂) are the positions of the vertices ν₁ and ν₂.

The same process is used to compute the texture coordinates of the newly created vertex. For normal vectors, an extra normalization step is applied as follows:

$$N ( {v}_{12} ) = \frac{N ( {v}_{1} ) + N ( {v}_{2} )}{‖ N ( {v}_{1} ) + N ( {v}_{2} ) ‖} ,$$

here:
N(ν₁₂), N(ν₁), and N(ν₂) are the normal vectors associated with the vertices ν₁₂, ν₁, and ν₂, respectively.
∥x∥ is the norm2 of the vector x.

V-DMC encoder 200 and V-DMC decoder 300 may be configured to apply wavelet transforms. Various wavelet transforms may be applied. The results reported for CfP are based on a linear wavelet transform.

The prediction process is defined as follows:

$$Signal ( v ) ← Signal ( v ) - \frac{1}{2} ( Signal ( {v}_{1} ) + Signal ( {v}_{2} ) )$$

where.
ν is the vertex introduced in the middle of the edge (ν₁, ν₂), and
Signal(ν), Signal(ν₁), and Signal(ν₂) are the values of the geometry/vertex attribute signals at the vertices ν, ν₁, and ν₂, respectively.

The updated process is as follows:

$$Signal ( v ) ← Signal ( v ) + \frac{1}{8} {\sum }_{w ∈ {v}^{*}} Signal ( w )$$

where ν* is the set of neighboring vertices of the vertex ν.

The process may allow to skip the update process. The wavelet coefficients could be quantized e.g., by using a uniform quantizer with a dead zone.

V-DMC encoder 200 and V-DMC decoder 300 may be configured to use local or canonical coordinate systems for displacements. The displacement field d(i) is defined in the same cartesian coordinate system as the input mesh. A possible optimization is to transform d(i) from this canonical coordinate system to a local coordinate system, which is defined by the normal to the subdivided mesh at each vertex.

The advantage of considering a local coordinate system for the displacements is the possibility to quantize more heavily the tangential components of the displacements compared to the normal component. In fact, the normal component of the displacement has more significant impact on the reconstructed mesh quality than the two tangential components.

V-DMC encoder 200 and V-DMC decoder 300 may be configured to pack (and unpack) wavelet coefficients. The following process may be used to pack the wavelet coefficients into a 2D image:
Traverse the coefficients from low to high frequency.
For each coefficient, determine the index of the N×M pixel block (e.g., N=M=16) in which it should be stored following a raster order for blocks.

The position within the N×M pixel block is computed by using a Morton order to maximize locality.

Other packing processes may also be used (e.g., zigzag order, raster order). The encoder may explicitly signal in the bitstream the used packing process (e.g., atlas sequence parameters). This could be done at patch, patch group, tile, or sequence level.

V-DMC encoder 200 and V-DMC decoder 300 may be configured to displacement video encoding and decoding.

The proposed process is agnostic as to which video coding technology is used. When coding the displacement wavelet coefficients, a lossless approach may be used since the quantization is applied in a separate module. Another approach is to rely on the video encoder to compress the coefficients in a lossy manner and apply a quantization either in the original or transform domain.

The following sections reproduce syntax and semantics from Working Draft (WD) 6.0 of V-DMC, ISO/IEC JTC1/SC29/WG7, N00822 (d25), January 2024 (hereinafter “WD 6.0”) that are related to the signaling of quantization parameters relevant to the coding of displacement wavelet coefficients (lifting process).

Aspects of the Atlas Metadata Sub-Bitstream will now be described.

Atlas Sequence Parameter Set from WD 6.0

Syntax elements that are relevant to the quantization process are shown between the delimiters <Q> and </Q>.

| | Descriptor |
|---|---|
| asps_vdmc_extension( ) { | |
| asve_subdivision_method | u(3) |
| if( asve_subdivision_method != 0 ) { | |
| <Q> asve_subdivision_iteration_count</Q> | u(3) |
| AspsSubdivisionCount = asve_subdivision_iteration_count | |
| } else | |
| AspsSubdivisionCount = 0 | |
| <Q> asve_1d_displacement_flag</Q> | u(1) |
| <Q> vdmc_quantization_parameters( 0, AspsSubdivisionCount ) </Q> | |
| asve_transform_method | u(3) |
| if(asve_transform_method == LINEAR_LIFTING) { | |
| vdmc_lifting_transform_parameters( 0, AspsSubdivisionCount ) | |
| } | |
| asve_num_attribute_video | u(7) |
| for(i=0; i< asve_num_attribute_video; i++){ | |
| asve_attribute_type_id[ i ] | u(8) |
| asve_attribute_frame_width[ i ] | ue(v) |
| asve_attribute_frame_height[ i ] | ue(v) |
| asve_attribute_subtexture_enabled_flag[ i ] | u(1) |
| } | |
| asve_packing_method | u(1) |
| asve_projection_textcoord_enable_flag | u(1) |
| if( asve_projection_textcoord_enable_flag ){ | |
| asve_projection_textcoord_mapping_method | u(2) |
| asve_projection_textcoord_scale_factor | fl(64) |
| } | |
| <Q> asve_displacement_reference_qp</Q> | u(7) |
| asve_vdmc_vui_parameters_present_flag | u(1) |
| if( asve_vdmc_vui_parameters_present_flag ) | |
| vdmc_vui_parameters( ) | |
| } | |

asve_subdivision_iteration_count indicates the number of iterations used for the subdivision. When not present the value of asve_subdivision_iteration_count is inferred to be equal to 0.

asve_1d_displacement_flag equal to 1 specifies that only the normal (or x) component of the displacement is present in the compressed geometry video. The remaining two components are inferred to be 0. asve_1D_displacement_flag equal to 0 specifies that all 3 components of the displacement are present in the compressed geometry video.

asve_displacement_reference_qp specifies the initial value of QuantizationParameter for current frame. When not present asve_displacement_reference_qp is set to be equal to 49.

The vdmc_quantization_parameters structure:

| | Descriptor |
|---|---|
| vdmc_quantization_parameters( qpIndex, subdivisionCount ){ | |
| vqp_lod_quantization_flag[ qpIndex ] | u(1) |
| vqp_bitdepth_offset[ qpIndex ] | se(v) |
| if( vqp_lod_quantization_flag[ qpIndex ] == 0 ) { | |
| for( k = 0; k < DisplacementDim; k++) { | |
| vqp_quantization_parameters[ qpIndex ][ k ] | u(7) |
| for( i=0 ; i < subdivisionCount + 1; i++ ) | |
| QuantizationParameter[ qpIndex ][ i ][ k ] = | |
| vqp_quantization_parameters[ qpIndex ][ k ] | |
| vqp_log2_lod_inverse_scale[ qpIndex ][ k ] | u(2) |
| } | |
| } else { | |
| for( i=0 ; i < subdivisionCount + 1; i++ ) { | |
| for( k = 0; k < DisplacementDim; k++ ) { | |
| vqp_lod_delta_quantization_parameter_value[ qpIndex ][ i ][ k ] | ue(v) |
| if( vqp_lod_delta_quantization_parameter_value[ qpIndex ][ i ][ k ] ) | |
| vqp_lod_delta_quantization_parameter_sign[ qpIndex ][ i ][ k ] | u(1) |
| if( qpIndex = 0 ) | |
| QuantizationParameter[ qpIndex ][ i ][ k ] = | |
| asve_displacement_reference_qp + ( 1 − 2 * | |
| vqp_lod_delta_quantization_parameter_sign[ qpIndex ][ I ][ K ] ) * | |
| vqp_lod_delta_quantization_parameter_value[ qpIndex ][ I ][ K ] | |
| else | |
| QuantizationParameter[ qpIndex ][ i ][ k ] = | |
| QuantizationParameter[ qpIndex − 1 ][ i ][ k ] + ( 1 − 2 * | |
| vqp_lod_delta_quantization_parameter_sign[ qpIndex ][ I ][ K ] ) * | |
| vqp_lod_delta_quantization_parameter_value[ qpIndex ][ I ][ K ] | |
| } | |
| } | |
| } | |
| vqp_direct_quantization_enabled_flag[ qpIndex ] | u(1) |
| } | |

vqp_lod_quantization_flag[qpIndex] equal to 1 indicates that the quantization parameter will be sent per level-of-detail using delta coding. vqp_lod_quantization_flag[qpIndex] equal to 0 indicates that the quantization parameter will be the same for all level-of-details. qpIndex is the index of the quantization parameter set.
vqp_bitdepth_offset[qpIndex] indicates the bit depth offset value applied to the quantization process of the displacements. qpIndex is the index of the quantization parameter set.
vqp_quantization_parameters[qpIndex][k] indicates the quantization parameter to be used for the inverse quantization of the k^{th}-component of the displacements. The value of vqp_quantization_parameters[qpIndex][k] shall be in the range of 0 to 100, inclusive. qpIndex is the index of the quantization parameter set.
vqp_log 2_lod_inverse_scale[qpIndex][k] indicates the scaling factor applied to the k^{th}-component of the displacements for each level of detail. qpIndex is the index of the quantization parameter set.

vqp_lod_delta_quantization_parameter_value[qpIndex][i][k] specifies the absolute difference of quantization parameter value between the value asve_displacement_reference_qp and the quantization parameter for the i^{th}-layer and k^{th}-component. When not present, the value of vqp_lod_delta_quantization_parameter_value[qpIndex][i][k] is inferred as 0. qpIndex is the index of the quantization parameter set. The value of QuantizationParameter of each LoD layer shall be in the range of 0 to 100.

vqp_lod_delta_quantization_parameter_sign[qpIndex][i][k] specifies the sign of difference of quantization parameter value between the value asve_displacement_reference_qp and the quantization parameter for the i^{th}-layer and k^{th}-component. vqp_lod_delta_quantization_parameter_sign[qpIndex][i][k] equal to 0 indicate the difference is positive. vqp_lod_delta_quantization_parameter_sign[qpIndex][i][k] equal to 1 indicate the difference is negative. When not present, the value of vqp_lod_delta_quantization_parameter_sign[qpIndex][i][k] is inferred as 0. qpIndex is the index of the quantization parameter set.
vqp_direct_quantization_enabled_flag[qpIndex] equal to 1 indicates that the inverse scale factor is derived from the signaled displacement quantization parameter directly and computed as follows:

$$InverseScale [ qpIndex ] [ i ] [ k ] = 1 \div QuantizationParameter [ qpIndex ] [ i ] [ k ]$$

vqp_direct_quantization_enabled_flag[qpIndex] equal to 0 indicates that the inverse scale factor shall be computed as follows:

$$bitDepthPosition = asps\_geometry \_ 3 d\_bit \_depth \_minus1 + 1 \\ InverseScale [ qpIndex ] [ i ] [ k ] = pow ( 0.5 , 16 + vqp\_bitdepth \_offset [ qpIndex ] - bitDepthPosition + ( 4 - QuantizationParameters [ qpIndex ] [ i ] [ k ] ) \div 6 )$$

qpIndex is the index of the quantization parameter set.
   Atlas Frame Parameter Set from WD 6.0

Syntax elements that are relevant to the quantization process are shown between the delimiters <Q> and </Q>.

| | Descriptor |
|---|---|
| afps_vdmc_extension( ) { | |
| <Q> afve_overriden_flag</Q> | u(1) |
| if( afve_overriden_flag ) { | |
| afve_subdivision_enable_flag | u(1) |
| <Q> afve_quantization_enable_flag</Q> | u(1) |
| afve_transform_method_enable_flag | u(1) |
| afve_transform_parameters_enable_flag | u(1) |
| } | |
| if( afve_subdivision_enable_flag ) { | |
| afve_subdivision_method | u(3) |
| if( afve_subdivision_method != 0 ) { | |
| afve_subdivision_iteration_count | u(3) |
| AfpsSubdivisonCount = afve_subdivision_iteration_count | |
| } else { | |
| AfpsSubdivisonCount = 0 | |
| } | |
| } else | |
| AfpsSubdivisonCount = AspsSubdivisionCount | |
| <Q> if( afve_quantization_enable_flag ) | |
| vdmc_quantization_parameters( 1, AfpsSubdivisonCount ) </Q> | |
| if( afve_transform_method_enable_flag ) | |
| afve_transform_method | u(3) |
| ... | |
| } | |

afve_overriden_flag equal to 1 indicates the parameters afve_subdivision_enable_flag, afve_transform_method_enable_flag, afve_transform_parameters_enable_flag and afve_attribute_parameter_overwrite_flag are present in the atlas frame parameter set extension.
afve_quantization_enable_flag equal to 1 indicates vdmc_quantization_parameters(qpIndex, subdivisionCount) syntax structure is present in the atlas frame parameter set extension. When afve_quantization_enable_flag is not present, its value is inferred to be equal to 0.
Meshpatch Data Unit from WD 6.0

Syntax elements that are relevant to the quantization process are shown between the delimiters <Q> and </Q>.

| | Descriptor |
|---|---|
| meshpatch_data_unit( tileID, patchIdx ) { | |
| mdu_submesh_id[ tileID ][ patchIdx ] | u(v) |
| mdu_vertex_count_minus1[ tileID ][ patchIdx ] | ue(v) |
| mdu_face_count_minus1[ tileID ][ patchIdx ] | ue(v) |
| mdu_2d_pos_x[ tileID ][ patchIdx ] | ue(v) |
| mdu_2d_pos_y[ tileID ][ patchIdx ] | ue(v) |
| mdu_2d_size_x_minus1[ tileID ][ patchIdx ] | ue(v) |
| mdu_2d_size_y_minus1[ tileID ][ patchIdx ] | ue(v) |
| <Q> mdu_parameters_override_flag[ tileID ][ patchIdx ] </Q> | u(1) |
| if( mdu_parameters_override_flag[ tileID ][ patchIdx ] ){ | |
| mdu_subdivision_override_flag[ tileID ][ patchIdx ] | u(1) |
| <Q> mdu_quantization_override_flag[ tileID ][ patchIdx ] </Q> | u(1) |
| mdu_transform_method_override_flag[ tileID ][ patchIdx ] | u(1) |
| mdu_transform_parameters_override_flag[ tileID ][ patchIdx ] | u(1) |
| } | |
| ... | |
| <Q> if(mdu_quantization_override_flag[ tileID ][ patchIdx ]) | |
| vdmc_quantization_parameters(2, PatchSubdivisionCount[ tileID ][ patchIdx ] | |
| ) </Q> | |
| ... | |
| } | |

mdu_parameters_override_flag[tileID][patchIdx] equal to 1 indicates the parameters mdu_subdivision_override_flag, mdu_quantization_override_flag, mdu_transform_method_override_flag, and mdu_transform_parameters_override_flag are present in a meshpatch with index patchIdx, in the current atlas tile, with tile ID equal to tileID.
mdu_quantization_override_flag[tileID][patchIdx] equal to 1 indicates vdmc_quantization_parameters (qpIndex, subdivisionCount) syntax structure is present in a meshpatch with index patchIdx, in the current atlas tile, with tile ID equal to tileID. When mdu_quantization_override_flag[tileID][patchIdx] is not present, its value is inferred to be equal to 0.

The variable QpIndex for the current patch may be derived as follows:

$$QpIndex = mdu\_quantization \_override \_flag [ tileID ] [ patchIdx ] ? 2 \\ afve\_quantization \_enable \_flag ? 1 : 0$$

Aspects of the arithmetic-Coded Displacement Sub-Bitstream will now be described. Syntax elements that are relevant to the quantization process are shown between the delimiters <Q> and </Q>.

Displacement Sequence Parameter Set (DSPS) from WD 6.0

| | Descriptor |
|---|---|
| displ_sequence_parameter_set_rbsp( ) { | |
| dsps_sequence_parameter_set_id | u(4) |
| dsps_codec_id | u(8) |
| dsps_profile_tier_level( ) | |
| dsps_range_log2_minus2 | u(2) |
| <Q> dsps_single_dimension_flag</Q> | u(1) |
| dsps_msb_align_flag | u(1) |
| dsps_log2_max_displ_frame_order_cnt_lsb_minus4 | ue(v) |
| dsps_max_dec_displ_frame_buffering_minus1 | ue(v) |
| dsps_long_term_ref_displ_frames_flag | u(1) |
| dsps_num_ref_displ_frame_lists_in_dsps | ue(v) |
| for( i = 0; i < | |
| dsps_num_ref_displ_frame_lists_in_dsps; i++ ) | |
| displ_ref_list_struct( i ) | |
| dsps_extension_present_flag | u(1) |
| if( dsps_extension_present_flag ) { | |
| dsps_extension_count_minus1 | u(7) |
| dsps_extension_length_minus1 | ue(v) |
| while( more_rbsp_data( ) ) | |
| dsps_extension_data_flag | u(1) |
| } | |
| rbsp_trailing_bits( ) | |
| } | |

dsps_single_dimension_flag indicates the number of dimensions for the displacements associated with the displacements. dsps_single_dimension_flag equal to 0 indicates three components for the displacements are used. dsps_single_dimension_flag equal to 1 indicates only normal component for the displacements is used.

$$MaxDimension = dsps\_single \_dimension \_flag ? 1 : 3$$

Displacement Frame Parameter Set (DFPS) from WD 6.0

| | Descriptor |
|---|---|
| displ_frame_parameter_set_rbsp( ) { | |
| dfps_displ_sequence_parameter_set_id | u(4) |
| dfps_displ_frame_parameter_set_id | u(4) |
| displ_information( ) | |
| dfps_output_flag_present_flag | u(1) |
| dfps_num_ref_idx_default_active_minus1 | ue(v) |
| dfps_additional_lt_dfoc_lsb_len | ue(v) |
| dfps_extension_present_flag | u(1) |
| if( dfps_extension_present_flag ) | |
| dfps_extension_8bits | u(8) |
| if( dfps_extension_8bits ) | |
| while( more_rbsp_data( ) ) | |
| dfps_extension_data_flag | u(1) |
| rbsp_trailing_bits( ) | |
| } | |

Displacement Data Unit Syntax from WD 6.0

| | Descriptor |
|---|---|
| displ_data_unit( displID ) { | |
| <Q> ddu_lod_count[ displID ] </Q> | ae(v) |
| for( i = 0; i < displ_lod_count; i++ ){ | |
| <Q> ddu_vertex_count_lod[ displID ][ i ] </Q> | ae(v) |
| ddu_num_subblock_lod[ displID ][ i ] | ae(v) |
| totalVertCount += ddu_vertex_count_lod[ displID ][ i ] | |
| } | |
| for ( k = 0; k < MaxDimension; k++ ){ | |
| for( level = 0; level < displ_lod_count; level++ ){ | |
| levelBlockSize[ level ] = vertCount[ level ] / ddu_num_subblock_lod[ level ] | |
| for ( block = 0; block < ddu_num_subblock_lod[ level ]; block ++ ){ | |
| ddu_nz_subBlock[ displID ][ k ][ block ] | ae(v) |
| if ( dpdu_nz_subBlock[ displID ][ k ][ block ]){ | |
| vStart[ level ] = | |
| ( level == 0? 0 : vStart[ level − 1 ] + vertCount[ level − 1 ]) | |
| vBlockStart[ level ][ block ] = | |
| vStart[ level ] + block * levelBlockSize[ level ] | |
| vBlockEnd[ level ][ block ] = | |
| min( vBlockStart[ level ][ block ] + | |
| levelBlockSize[ level ], totalVertCount ) | |
| for( v= vBlockStart[ level ][ block ];v < vBlockEnd[ level ][ block ]; v++ ){ | |
| ddu_coeff_abs_level_gt0[ displID ][ k ][ v ] | ae(v) |
| if( ddu_coeff_abs_level_gt0[ displID ][ k ][ v ] ) { | |
| ddu_coeff_abs_level_gt1[ displID ][ k ][ v ] | ae(v) |
| ddu_coeff_sign[ displID ][ k ][ v ] | u(1) |
| if( ddu_coeff_abs_level_gt1[ displID ][ k ][ v ] ) { | |
| ddu_coeff_abs_level_gt2[ displID ][ k ][ v ] | ae(v) |
| if( ddu_coeff_abs_level_gt2[ displID ][ k ][ v ] ) { | |
| ddu_coeff_abs_level_gt0 | ae(v) |
| [ displID ][ k ][ v ] | |
| if( ddu_coeff_abs_level_gt3[ displID ][ k ][ v ]) { | |
| ddu_coeff_abs_level_rem[ displID ][ k ][ v ] | ae(v) |
| } | |
| } | |
| } | |
| } | |
| } //v | |
| }//uf | |
| }//block | |
| }//level | |
| }//k | |
| } | |

ddu_lod_count[displID] indicates the number of the subdivision levels used for the displacement signaled in the data unit associated with displId displID.
ddu_vertex_count_lod[displID][i] indicates the number of displacements for the i-th level of wavelet transform for the data unit associated with displId displID.

As described above with respect to displacement coding, inter prediction is performed on quantized wavelet coefficients (lifting process) after the arithmetic decoding of displacements. More recently, the proposal H. Nishimura, K. Kawamura, K. Kishimoto, J. Xu, “[V-DMC][EE4.7 Test 5.1] Quantization after Inter Prediction in Arithmetic Coding-based Displacement Coding,” ISO/IEC JTC1/SC29/WG7, m64391, July 2023 (hereinafter “m64391”) introduced inter prediction of the wavelet coefficients themselves after inverse quantization as is illustrated in. The inverse quantized coefficients (residuals) are added to the inter predicted values that are stored in the frame buffer. The benefit is that correlation between wavelet coefficients of adjacent frames is greater than the correlation between the corresponding quantized coefficients, which results in additional coding efficiency gains. However, the inverse quantization process is implemented as floating point operations, which are known to produce results that are operation order and platform implementation dependent. As the reconstructed wavelet coefficients are stored in the frame buffer for inter prediction, the floating-point operations may result in different reconstructed wavelet coefficients at the encoder and decoder if the implementation differs.

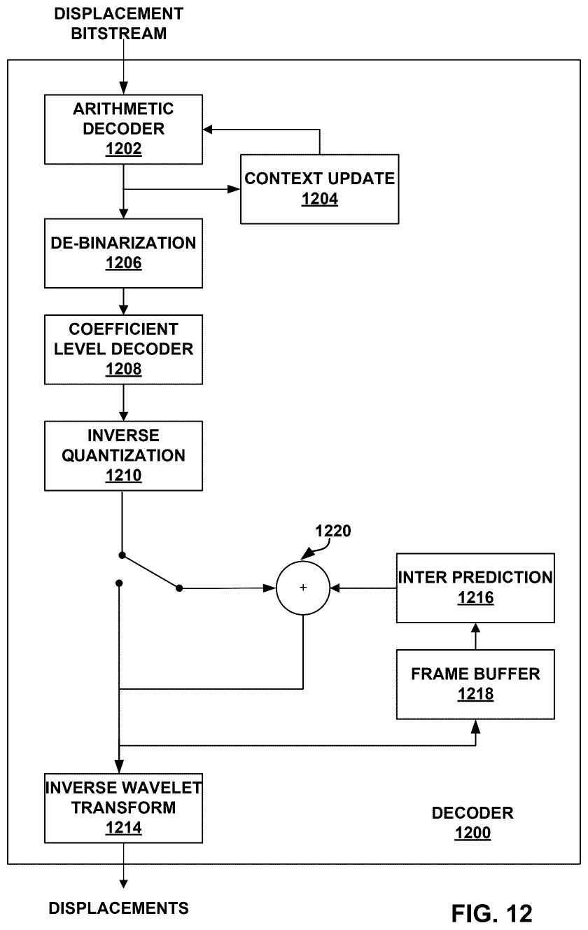

FIG. 12 shows an arithmetic decoding process of a displacements bitstream. In the example of FIG. 12, decoder 1200 performs context-based arithmetic decoding 1202 of a displacement bitstream based on a context update 1204. Decoder 1200 performs de-binarization 1206 on the context decoded bitstream to determine values for syntax elements and performs coefficient level decoding 1208 on the syntax elements. Decoder 1200 then inverse quantizes 1210 the coefficient level to determine dequantized coefficients. For intra coded displacements, decoder 1200 performs an inverse wavelet transform 1214 on the de-quantized coefficient levels to determine the displacements. For inter coded displacements, decoder 1200 performs inter prediction 1016 using reference frames stored in a frame buffer 1218 and adds 1220 the prediction values to the dequantized coefficient levels to determine final dequantized coefficient levels. Decoder 1200 then performs an inverse wavelet transform 1214 on the final de-quantized coefficient levels to determine the displacements.

According to the techniques of this disclosure, V-DMC encoder 200 and V-DMC decoder 300 may be configured to perform displacement wavelet coefficient inter prediction with fixed-point inverse quantization. This disclosure describes techniques to integrate the fixed-point (or integer) inverse quantizer, as described in U.S. Provisional Patent Application 63/586,120, filed 28 Sep. 2023, to mitigate the potential drift problem due to floating point operations in the inverse quantizer process. In addition, the integer arithmetic may be deterministically specified in the standard specification.

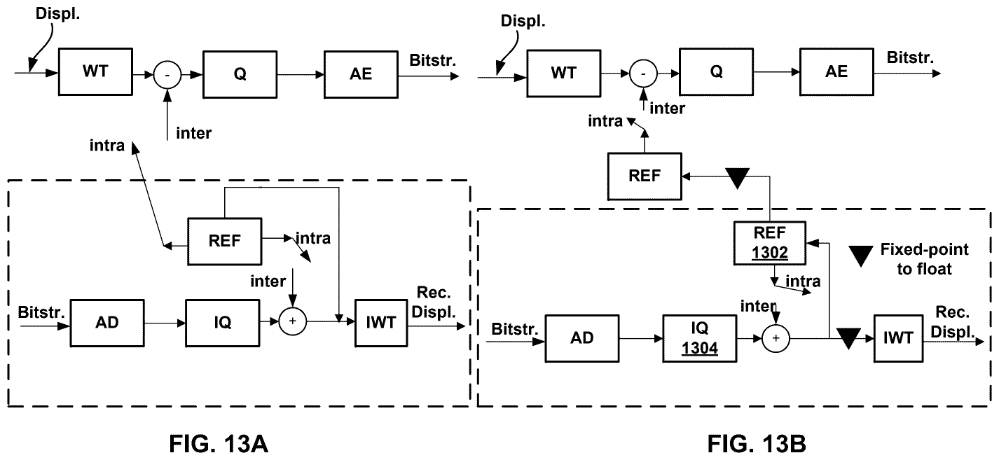

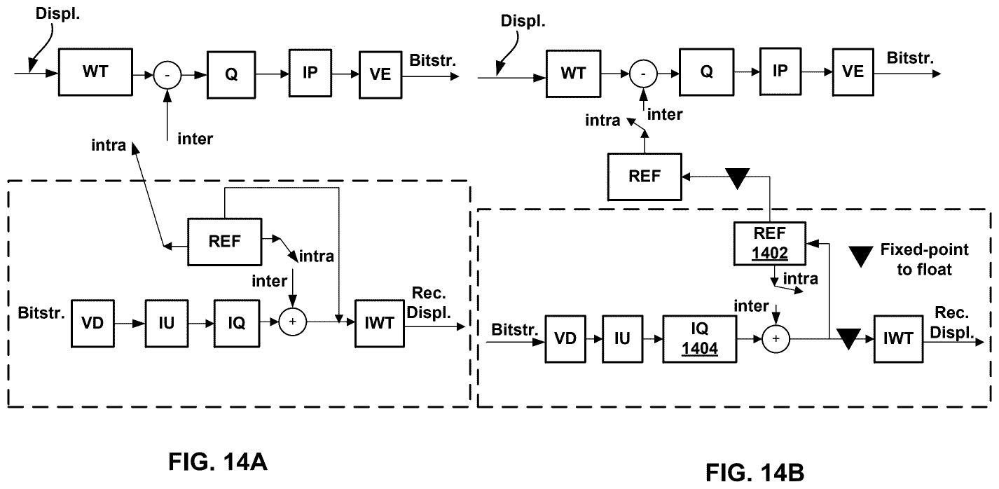

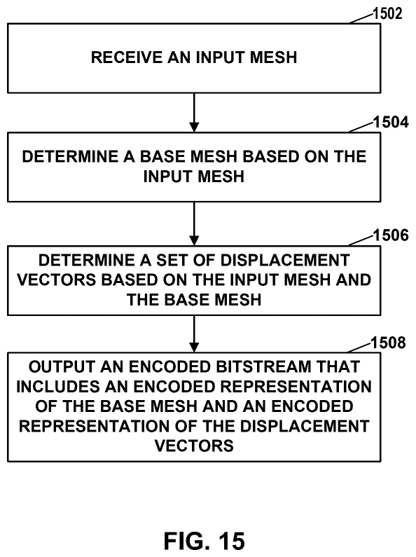

As proposed in U.S. Provisional Patent Application 63/620,665 and in Geert Van der Auwera, Adarsh Krishnan Ramasubramonian, Reetu Hooda, Anique Akhtar, Marta Karczewicz, “[V-DMC][EE4.7 Test5-related] V-DMC Displacement Wavelet Coefficient Inter Prediction with Fixed-Point Quantization,” ISO/IEC JTC1/SC29/WG7, m66302, January 2024 (hereinafter “m66302”). The fixed-point inverse quantizer is integrated to mitigate the potential drift problem due to floating point operations in the inverse quantizer process as illustrated in FIGS. 13A, 13B, 14A, and 14B.

FIG. 13A illustrates the process described in m64391 and is a simplified version of FIG. 12. FIG. 13A illustrates an arithmetic process for encoding and decoding displacements. At the encoder side, after wavelet transforming (WT) the displacements (1D or 3D), a predictor from the reference buffer (REF) is subtracted and subsequently quantized (Q). The arithmetic encoder (AE) codes the quantized residuals into the bitstream (Bitstr.). At the decoder side the displacements are reconstructed (Rec. Displ.). The reconstructed wavelet coefficients are obtained after arithmetic decoding (AD), inverse quantization (IQ), and adding the predictors from the reference buffer. These coefficients that are obtained before the inverse wavelet transform (IWT) may also be used on the encoder side to be stored in the reference buffer for predicting future frames of wavelet coefficients.

FIG. 13B illustrates an arithmetic process for decoding. After arithmetic decoding, the fixed-point (integer) inverse quantization process (IQ 1304) (U.S. Provisional Patent Application 63/586,120) is applied). The AD outputs integer type residuals that may be converted to fixed-point values, for example, by left bit shifting. Subsequently the inverse quantized residuals are added to the predictors from the reference buffer (1302), which were also stored as fixed-point values. In this encoder example, the IWT is implemented in floating-point arithmetic as well as the encoder's reference buffer, hence, a conversion from fixed-point to floating point is included (downwards triangles).

FIGS. 14A and 14B illustrate a video-based process for encoding and decoding displacements. In FIG. 14A, after wavelet transforming (WT) the displacements (1D or 3D), a predictor from the reference buffer (REF) is subtracted and subsequently quantized (Q). The image packer (IP) packs the quantized residuals into a frame, i.e., an image, and a video encoder (VE) encodes the frame. At the decoder side, the displacements are reconstructed (Rec. Displ.). The reconstructed wavelet coefficients are obtained after video decoding (VD), image unpacking (IU), and inverse quantization (IQ), and adding the predictors from the reference buffer. These coefficients that are obtained before the inverse wavelet transform (IWT) are also stored on the encoder side for predicting future frames of wavelet coefficients.

FIG. 14B illustrates a video-based process for encoding and decoding displacements. After video decoding (VD) and image unpacking (IU), the fixed-point (integer) inverse quantization process (IQ 1404) (U.S. Provisional Patent Application 63/586,120) is applied. The inverse quantized residuals are added to the predictors from the reference buffer (1402), which were also stored as fixed-point values. In this example, the IWT is implemented in floating-point arithmetic as well as the encoder's reference buffer, hence, a conversion from fixed-point to floating point is included (downwards triangles).

According to the techniques of this disclosure, V-DMC encoder 200 and V-DMC decoder 300 may perform signaling of quantization parameters in the Arithmetic-Coded Displacement Sub-Bitstream for Displacement Inter Prediction with Fixed-Point Inverse Quantization.

The proposed techniques of this disclosure apply to arithmetic coding of the displacements or alternative coding methods such as variable length coding, neural network-based coding, etc. It is understood that the multiple coding approaches can be unified with the fixed-point inverse quantizer and reference buffer implementations.

In V-DMC, the quantized displacement vector wavelet coefficients can be packed in a 2D video frame and coded with a video encoder or coded directly with an arithmetic encoder. In either case, the resulting bitstreams are encapsulated in the V3C syntax described in WD 1.0 for the 4^{th} edition of V3C, ISO/IEC JTC1/SC29/WG7, N00797, January 2024 (hereinafter “WD 1.0”) and are considered sub-bitstreams of this syntax. Examples of other sub-bitstreams are the base mesh sub-bitstream, atlas metadata sub-bitstream, texture sub-bitstream, other attributes sub-bitstream, etc.

To reconstruct the displacement vector wavelet coefficients according to the processes presented in the previous section, the inverse quantization process uses parameters from the bitstream such as displacement vector dimension, quantization parameters (QP), number of levels of detail (LoDs), number of vertices per LoD, etc. In V-DMC some of these parameters are signaled as part of the atlas metadata sub-bitstream from WD 6.0 per the syntax tables above.

On the other hand, the arithmetic-coded (AC) displacement sub-bitstream WD 6.0 does not contain the parameters that the inverse quantization process requires for reconstructing the displacement vector wavelet coefficients from this sub-bitstream without relying on the atlas metadata sub-bitstream. It may be a requirement of V3C or V-DMC that the AC displacement sub-bitstream is self-contained so that a decoder does not have to rely on other sub-bitstreams for reconstruction of displacement wavelet coefficients.

It is observed that quantization parameters are currently missing from the AC displacement sub-bitstream. Therefore, this disclosure proposes to add those parameters from the atlas metadata sub-bitstream that are required for self-contained reconstruction of displacement wavelet coefficients, for example:
asve_displacement_reference_qp (ASPS): It is proposed to add this parameter to the DSPS, which is equivalent to the ASPS, as well as other parameters such as number of mesh subdivisions and mesh vertex position bit depth that are required for inverse quantization.
afve_quantization_enable_flag (AFPS): It is proposed to add this parameter to the DFPS, which is equivalent to the AFPS.
mdu_quantization_override_flag (meshpatch_data_unit): There is currently no displacement data unit at the meshpatch level defined.
vdmc_quantization_parameters( ) This data is currently not included and most parameters may need to be added.
   As follows, with additions being shown between the delimiters <add> and </add>:

| | Descriptor |
|---|---|
| displ_sequence_parameter_set_rbsp( ) { | |
| dsps_sequence_parameter_set_id | u(4) |
| dsps_codec_id | u(8) |
| dsps_profile_tier_level( ) | |
| dsps_range_log2_minus2 | u(2) |
| dsps_single_dimension_flag | u(1) |
| dsps_msb_align_flag | u(1) |
| dsps_log2_max_displ_frame_order_cnt_lsb_minus4 | ue(v) |
| dsps_max_dec_displ_frame_buffering_minus1 | ue(v) |
| dsps_long_term_ref_displ_frames_flag | u(1) |
| dsps_num_ref_displ_frame_lists_in_dsps | ue(v) |
| for( i = 0; i < dsps_num_ref_displ_frame_lists_in_dsps; i++ ) | |
| displ_ref_list_struct( i ) | |
| <add> dsps_geometry_3d_bit_depth_minus1 | u(5) |
| dsps_subdivision_method | u(3) |
| if( dsps_subdivision_method != 0 ) { | |
| dsps_subdivision_iteration_count | u(3) |
| dspsSubdivisionCount = dsps_subdivision_iteration_count | |
| } else | |
| dspsSubdivisionCount = 0 | |
| dsps_displacement_reference_qp | u(7) |
| displ_quantization_parameters( 0, dspsSubdivisionCount ) </add> | |
| dsps_extension_present_flag | u(1) |
| if( dsps_extension_present_flag ) { | |
| dsps_extension_count_minus1 | u(7) |
| dsps_extension_length_minus1 | ue(v) |
| while( more_rbsp_data( ) ) | |
| dsps_extension_data_flag | u(1) |
| } | |
| rbsp_trailing_bits( ) | |
| } | |

dsps_subdivision_method indicates the identifier of the method to subdivide the meshes associated with the current displacement sequence parameter set. The following table describes the list of supported subdivision methods and their relationship with dsps_subdivision_method.

TABLE 1
Subdivision methods list

| dsps_subdivision_method | Name of subdivision method |
|---|---|
| 0 | NONE |
| 1 | MIDPOINT |
| 2 . . . 7 | RESERVED |

deps_subdivision_iteration_count indicates the number of iterations used for the subdivision. When not present the value of dsps_subdivision_iteration_count is inferred to be equal to 0.
deps_displacement_reference_qp specifies the initial value of QuantizationParameter for current frame. When not present asve_displacement_reference_qp is set to be equal to 49.

| | Descriptor |
|---|---|
| <add> displ_quantization_parameters( qpIndex, subdivisionCount ){ </add> | |
| <add> dqp_lod_quantization_flag[ qpIndex ] </add> | u(1) |
| <add> dqp_bitdepth_offset[ qpIndex ] </add> | se(v) |
| if( dqp_lod_quantization_flag[ qpIndex ] == 0 ) { | |
| for( k = 0; k < DisplacementDim; k++) { | |
| <add> dqp_quantization_parameters</add> [ qpIndex ][ k ] | u(7) |
| for( i=0 ; i < subdivisionCount + 1; i++ ) | |
| QuantizationParameter[ qpIndex ][ i ][ k ] = | |
| dqp_quantization_parameters[ qpIndex ][ k ] | |
| <add> dqp_log2_lod_inverse_scale</add> [ qpIndex ][ k ] | u(2) |
| } | |
| } else { | |
| for( i=0 ; i < subdivisionCount + 1; i++ ) { | |
| for( k = 0; k < DisplacementDim; k++ ) { | |
| <add> | ue(v) |
| dqp_lod_delta_quantization_parameter_value</add> [ qpIndex ][ i ][ k ] | |
| if( dqp_lod_delta_quantization_parameter_value[ qpIndex ][ i ][ k ] ) | |
| <add> | u(1) |
| dqp_lod_delta_quantization_parameter_sign</add> [ qpIndex ][ i ][ k ] | |
| if( qpIndex = 0 ) | |
| QuantizationParameter[ qpIndex ][ i ][ k ] = | |
| dsps_displacement_reference_qp + ( 1 − 2 * | |
| dqp_lod_delta_quantization_parameter_sign[ qpIndex ][ I ][ K] ) * | |
| dqp_lod_delta_quantization_parameter_value[ qpIndex ][ I ][ K ] | |
| else | |
| QuantizationParameter[ qpIndex ][ i ][ k ] = | |
| QuantizationParameter[ qpIndex − 1 ][ i ][ k ] + ( 1 − 2 * | |
| dqp_lod_delta_quantization_parameter_sign[ qpIndex ][ I ][ K ] ) * | |
| dqp_lod_delta_quantization_parameter_value[ qpIndex ][ I ][ K ] | |
| } | |
| } | |
| } | |
| } | |

dqp_lod_quantization_flag[qpIndex] equal to 1 indicates that the quantization parameter will be sent per level-of-detail using delta coding. dqp_lod_quantization_flag[qpIndex] equal to 0 indicates that the quantization parameter will be the same for all level-of-details. qpIndex is the index of the quantization parameter set.

dqp_bitdepth_offset[qpIndex] indicates the bit depth offset value applied to the quantization process of the displacements. qpIndex is the index of the quantization parameter set.

dqp_quantization_parameters[qpIndex][k] indicates the quantization parameter to be used for the inverse quantization of the k^{th}-component of the displacements. The value of dqp_quantization_parameters[qpIndex][k] shall be in the range of 0 to 100, inclusive. qpIndex is the index of the quantization parameter set.
dqp_log 2_lod_inverse_scale[qpIndex][k] indicates the scaling factor applied to the k^{th}-component of the displacements for each level of detail. qpIndex is the index of the quantization parameter set.
dqp_lod_delta_quantization_parameter_value[qpIndex][i][k] specifies the absolute difference of quantization parameter value between the value dsps_displacement_reference_qp and the quantization parameter for the i^{th}-layer and k^{th}-component. When not present, the value of dqp_lod_delta_quantization_parameter_value[qpIndex][i][k] is inferred as 0. qpIndex is the index of the quantization parameter set. The value of QuantizationParameter of each LoD layer shall be in the range of 0 to 100.
dqp_lod_delta_quantization_parameter_sign[qpIndex][i][k] specifies the sign of difference of quantization parameter value between the value dsps_displacement_reference_qp and the quantization parameter for the i^{th}-layer and k^{th}-component. dqp_lod_delta_quantization_parameter_sign[qpIndex][i][k] equal to 0 indicate the difference is positive. dqp_lod_delta_quantization_parameter_sign[qpIndex][i][k] equal to 1 indicate the difference is negative. When not present, the value of dqp_lod_delta_quantization_parameter_sign[qpIndex][i][k] is inferred as 0. qpIndex is the index of the quantization parameter set.

The inverse scale factor may be computed as follows:

$$bitDepthPosition = < add > dsps\_geometry \_ 3 d\_bit \_depth \_minus1 \text{</add>} + 1 \\ InverseScale [ qpIndex ] [ i ] [ k ] = pow ( 0.5 , 16 + dqp\_bitdepth \_offset [ qpIndex ] - bitDepthPosition + ( 4 - QuantizationParameters [ qpIndex ] [ i ] [ k ] ) \div 6 )$$

qpIndex is the index of the quantization parameter set.

Note that asps_geometry_3d_bit_depth_minus1 is not currently defined in the WD 6.0. Therefore, it is proposed to include it in the ASPS as well as in the DSPS.

asps_geometry_3d_bit_depth_minus1 plus 1 indicates the bit depth of vertex coordinates in the mesh. asps_geometry_3d_bit_depth_minus1[j] shall be in the range of 0 to 31, inclusive.
dsps_geometry_3d_bit_depth_minus1 plus 1 indicates the bit depth of vertex coordinates in the mesh. dsps_geometry_3d_bit_depth_minus1[j] shall be in the range of 0 to 31, inclusive.
In some examples, the minimum bit depth can be set equal to 4, for example:
asps_geometry_3d_bit_depth_minus4 plus 4 indicates the bit depth of vertex coordinates in the mesh. asps_geometry_3d_bit_depth_minus4[j] shall be in the range of 0 to 31, inclusive.
dsps_geometry_3d_bit_depth_minus4 plus 4 indicates the bit depth of vertex coordinates in the mesh. dsps_geometry_3d_bit_depth_minus4[j] shall be in the range of 0 to 31, inclusive.

Currently, in WD 6.0, the meshpatch data unit described in Danillo B Graziosi, Alexandre Zaghetto, Ali Tabatabai, “[V-DMC][WD] Meshpatch concept for VDMC,” ISO/IEC JTC1/SC29/WG7, m65886, January 2024 is not defined in the AC displacement sub-bitstream syntax. Nevertheless, the AC displacement sub-bitstream can be organized and coded according to the meshpatch concept of the atlas metadata sub-bitstream and quantization parameters can be signaled in such a displacement meshpatch data unit.

In some examples, when syntax elements associated with the quantization of displacements are signaled in the AC displacement sub-bitstream and the atlas sub-bitstream, it is requirement of bitstream conformance that the values of corresponding syntax elements do not contradict one another. the E.g., if dsps_subdivision_iteration_count is 2, the value of asve_subdivision_iteration_count is also 2.

In some examples, one or more syntax elements may be signaled in the atlas sub-bitstream that specify whether syntax elements associated with the displacement quantization are signaled in the atlas sub-bitstream (e.g., value 0 indicates syntax elements are not signaled in the atlas sub-bitstream, and value 1 indicates that they are signaled in the atlas sub-bitstream.)

In some examples, only some syntax elements associated with the displacement quantization may not be signaled in the atlas sub-bitstream based on the value of the syntax element.

According to the techniques of this disclosure, V-DMC encoder 200 and V-DMC decoder 300 may perform signaling of quantization parameters in the Video-Coded Displacement Sub-Bitstream for Displacement Inter Prediction with Fixed-Point Inverse Quantization.

The techniques of this disclosure apply to video coding of the displacements. It is understood that multiple video coding approaches can be unified with the fixed-point inverse quantizer and reference buffer implementations as illustrated in FIGS. 14A and 14B and proposed in U.S. Provisional Patent Application 63/620,665 and in m66302.

In V-DMC, the quantized displacement vector wavelet coefficients can be packed in a 2D video frame and coded with a video encoder or coded directly with an arithmetic encoder. In either case, the resulting bitstreams are encapsulated in the V3C syntax as described in WD 1.0 and are considered sub-bitstreams of this syntax. Examples of other sub-bitstreams are: base mesh, atlas metadata, texture, other attributes, etc.

To reconstruct the displacement vector wavelet coefficients, the inverse quantization process uses parameters from the bitstream such as displacement vector dimension, quantization parameters (QP), number of levels of detail (LoDs), number of vertices per LoD, etc. In V-DMC some of these parameters are signaled as part of the atlas metadata sub-bitstream of WD 6.0 per the syntax tables above.

On the other hand, the video-coded displacement sub-bitstream, which is coded as an attribute sub-bitstream, does not contain the parameters that the inverse quantization process requires for reconstructing the displacement vector wavelet coefficients from this sub-bitstream without relying on the atlas metadata sub-bitstream. It may be a requirement of V3C or V-DMC that the video-coded displacement sub-bitstream is self-contained so that a decoder does not have to rely on other sub-bitstreams for reconstruction of displacement wavelet coefficients.

Therefore, this disclosure describes techniques to integrate the quantization parameters and other required parameters in the video frame. These parameters may be losslessly coded as binary values by assigning them to pixel values in the video frame. If the bitdepth of a parameter is larger than the pixel bitdepth of the video frame, then multiple pixel values may be used to represent this parameter. In general, the parameters can be coded in the luminance or chrominance components of the video frame, or in the color components such as RGB. The parameters may be grouped inside a block within the video frame or a line of the video frame or other region. A slice or other partitioning of the video frame may be dedicated to the signaling of these parameters. In all cases the exact format and order of this proposed packing is determined so that a decoder can parse the parameters from the video frame. Parameters may be signaled per sequence, per frame, per submesh region, slice, tile, etc.

In some examples, the quantization parameters and other required parameters may be signaled in an SEI message that is signaled in the video bitstream.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

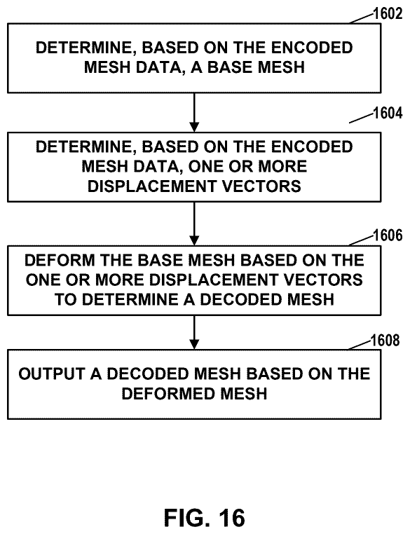

FIG. 16 is a flowchart illustrating an example process for decoding a compressed bitstream of mesh data. Although described with respect to V-DMC decoder 300 (FIGS. 1 and 3), it should be understood that other devices may be configured to perform a process similar to that of FIG. 16.

In the example of FIG. 16, V-DMC decoder 300 determines, based on the encoded mesh data, a base mesh (1602). V-DMC decoder 300 determines, based on the encoded mesh data, one or more displacement vectors (1604). V-DMC decoder 300 deforms the base mesh using the one or more displacement vectors (1606). For example, the base mesh may have a first set of vertices, and V-DMC decoder 300 may subdivide the base mesh to determine an additional set of vertices for the base mesh. To deform the base mesh, V-DMC decoder 300 may modify the locations of the additional set of vertices based on the one or more displacement vectors. V-DMC decoder 300 outputs a decoded mesh based on the deformed mesh (1608). V-DMC decoder 300 may, for example, output the decoded mesh for storage, transmission, or display.

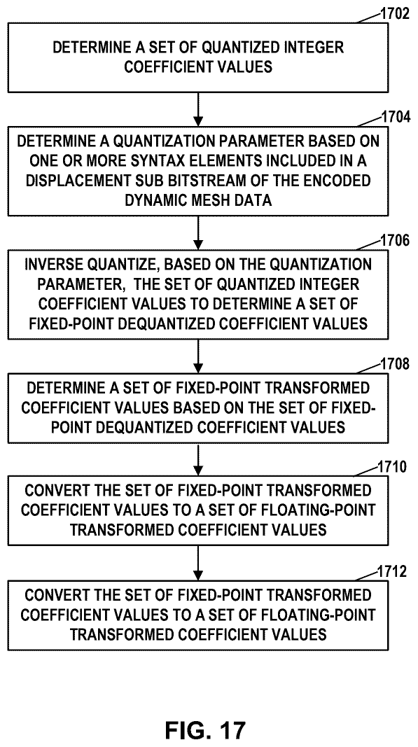

FIG. 17 is a flowchart illustrating an example process for decoding a compressed bitstream of mesh data. Although described with respect to V-DMC decoder 300 (FIGS. 1 and 3), it should be understood that other devices may be configured to perform a process similar to that of FIG. 17.

In the example of FIG. 17, V-DMC decoder 300 determines a set of quantized integer coefficient values (1702). V-DMC decoder 300 determines a quantization parameter based on one or more syntax elements included in a displacement sub-bitstream of the encoded dynamic mesh data (1704). To determine the quantization parameter based on the one or more syntax elements included in the displacement sub-bitstream of the encoded dynamic mesh data, V-DMC decoder 300 may be configured to receive a first syntax element indicating an initial value for the quantization parameter for a current frame. To determine the quantization parameter based on the one or more syntax elements included in the displacement sub-bitstream of the encoded dynamic mesh data, V-DMC decoder 300 may be configured to receive a delta value indicating a difference between the initial value for the quantization parameter and a new quantization parameter. The first syntax element may, for example, be included in a sequence parameter set of the displacement sub-bitstream.

V-DMC decoder 300 inverse quantizes the set of quantized integer coefficient values to determine a set of fixed-point dequantized coefficient values (1706). V-DMC decoder 300 may be configured to inverse quantize, based on the quantization parameter, the set of quantized integer coefficient values to determine the set of fixed-point dequantized coefficient values without reference to any parameters included in a sub-bitstreams other than the displacement sub-bitstream. To determine the set of fixed-point transformed coefficient values based on the set of fixed-point dequantized coefficient values, V-DMC decoder 300 may be configured to determine that the set of fixed-point transformed coefficient values are equal to the set of fixed-point dequantized coefficient values. In other examples, to determine the set of fixed-point transformed coefficient values based on the set of fixed-point dequantized coefficient values, V-DMC decoder 300 may be configured to add a set of reference values to the set of fixed-point dequantized coefficient values.

V-DMC decoder 300 determines a set of fixed-point transformed coefficient values based on the set of fixed-point dequantized coefficient values (1708). V-DMC decoder 300 converts the set of fixed-point transformed coefficient values to a set of floating-point transformed coefficient values (1710). V-DMC decoder 300 inverse transforms the set of floating-point transformed coefficient values to determine a set of reconstructed displacement vectors (1712). To inverse transform the set of floating-point transformed coefficient values to determine the set of reconstructed displacement vectors, V-DMC decoder 300 may be configured to apply an inverse wavelet transform to the set of floating-point transformed coefficient values.

V-DMC decoder 300 may store the set of fixed-point transformed coefficient values in a reference buffer. V-DMC decoder 300 may additionally determine a second set of quantized integer coefficient values; inverse quantize the second set of quantized integer coefficient values to determine a second set of fixed-point dequantized coefficient values; determine a second set of fixed-point transformed coefficient values based on the set of fixed-point dequantized coefficient values and the set of fixed-point transformed coefficient values stored in the reference buffer; convert the second set of fixed-point transformed coefficient values to a second set of floating-point transformed coefficient values; and inverse transform the second set of floating-point transformed coefficient values to determine a second set of reconstructed displacement vectors.

V-DMC decoder 300 may modify a base mesh based on reconstructed displacement vectors to determine a reconstructed deformed mesh and apply decoded attributes to the reconstructed deformed mesh to determine a reconstructed dynamic mesh sequence. V-DMC decoder 300 may output the reconstructed dynamic mesh sequence for display, storage, transmission, or other purposes.

The techniques of this disclosure may apply to both arithmetic coding and video-based coding architectures, or other coding methods such as variable length coding, neural network-based coding, etc. It is understood that the multiple coding approaches can be unified with the fixed-point inverse quantizer and reference buffer implementations.

The following numbered clauses illustrate one or more aspects of the devices and techniques described in this disclosure.

The following numbered clauses illustrate one or more aspects of the devices and techniques described in this disclosure.

Clause 1. A device for decoding encoded dynamic mesh data, the device comprising: one or more memories; and one or more processors, implemented in circuitry and in communication with the one or more memories, configured to: determine a set of quantized integer coefficient values for displacement vectors of the encoded dynamic mesh data; determine a quantization parameter based on one or more syntax elements included in a displacement sub-bitstream of the encoded dynamic mesh data; inverse quantize, based on the quantization parameter, the set of quantized integer coefficient values to determine a set of fixed-point dequantized coefficient values; determine a set of fixed-point transformed coefficient values based on the set of fixed-point dequantized coefficient values; convert the set of fixed-point transformed coefficient values to a set of floating-point transformed coefficient values; inverse transform the set of floating-point transformed coefficient values to determine a set of reconstructed displacement vectors; and determine a reconstructed deformed mesh based on the set of reconstructed displacement vectors.

Clause 2. The device of clause 1, wherein to determine the quantization parameter based on the one or more syntax elements included in the displacement sub-bitstream of the encoded dynamic mesh data, the one or more processors are configured to: receive a first syntax element indicating an initial value for the quantization parameter for a first level of detail; and receive a second syntax element indicating a difference between the initial value for the quantization parameter and a new quantization parameter for a second level of detail.

Clause 3. The device of clause 2, wherein the first syntax element is included in a sequence parameter set of the displacement sub-bitstream.

Clause 4. The device of any of clauses 1-3, wherein to determine the set of fixed-point transformed coefficient values based on the set of fixed-point dequantized coefficient values, the one or more processors are configured to add the set of fixed-point transformed coefficient values to a set of predicted transformed coefficient values.

Clause 5. The device of any of clauses 1-4 wherein the one or more processors are configured to inverse quantize, based on the quantization parameter, the set of quantized integer coefficient values to determine the set of fixed-point dequantized coefficient values without reference to any parameters included in a sub-bitstream other than the displacement sub-bitstream.

Clause 6. The device of any of clauses 1-5, wherein the one or more processors are further configured to store the set of fixed-point transformed coefficient values in a reference buffer.

Clause 7. The device of clause 6, wherein the one or more processors are further configured to: determine a second set of quantized integer coefficient values; inverse quantize the second set of quantized integer coefficient values to determine a second set of fixed-point dequantized coefficient values; determine a second set of fixed-point transformed coefficient values based on the set of fixed-point dequantized coefficient values and the set of fixed-point transformed coefficient values stored in the reference buffer; convert the second set of fixed-point transformed coefficient values to a second set of floating-point transformed coefficient values; and inverse transform the second set of floating-point transformed coefficient values to determine a second set of reconstructed displacement vectors.

Clause 8. The device of any of clauses 1-7, wherein to inverse transform the set of floating-point transformed coefficient values to determine the set of reconstructed displacement vectors, the one or more processors are further configured to apply an inverse wavelet transform to the set of floating-point transformed coefficient values.

Clause 9. The device of any of clauses 1-8, wherein the one or more processors are further configured to modify a base mesh based on reconstructed displacement vectors to determine the reconstructed deformed mesh.

Clause 10. The device of clause 9, wherein the one or more processors are further configured to apply decoded attributes to the reconstructed deformed mesh to determine a reconstructed dynamic mesh sequence.

Clause 11. A method for decoding encoded dynamic mesh data, the method comprising: determining a set of quantized integer coefficient values for displacement vectors of the encoded dynamic mesh data; determining a quantization parameter based on one or more syntax elements included in a displacement sub-bitstream of the encoded dynamic mesh data; inverse quantizing, based on the quantization parameter, the set of quantized integer coefficient values to determine a set of fixed-point dequantized coefficient values; determining a set of fixed-point transformed coefficient values based on the set of fixed-point dequantized coefficient values; converting the set of fixed-point transformed coefficient values to a set of floating-point transformed coefficient values; inverse transforming the set of floating-point transformed coefficient values to determine a set of reconstructed displacement vectors; and determining a reconstructed deformed mesh based on the set of reconstructed displacement vectors.

Clause 12. The method of clause 11, wherein determining the quantization parameter based on the one or more syntax elements included in the displacement sub-bitstream of the encoded dynamic mesh data comprises receiving a first syntax element indicating an initial value for the quantization parameter for a current frame.

Clause 13. The method of clause 12, wherein determining the quantization parameter based on the one or more syntax elements included in the displacement sub-bitstream of the encoded dynamic mesh data comprises receiving a delta value indicating a difference between the initial value for the quantization parameter and a new quantization parameter.

Clause 14. The method of clause 12, wherein the first syntax element is included in a sequence parameter set of the displacement sub-bitstream.

Clause 15. The method of clause 11, further comprising inverse quantizing, based on the quantization parameter, the set of quantized integer coefficient values to determine the set of fixed-point dequantized coefficient values without reference to any parameters included in a sub-bitstream other than the displacement sub-bitstream.

Clause 16. A device for encoding dynamic mesh data, the device comprising: one or more memories; and one or more processors, implemented in circuitry and in communication with the one or more memories, configured to: determine a set of integer coefficient values for displacement vectors of the encoded dynamic mesh data; determine a quantization parameter; quantize, based on the quantization parameter, the set of integer coefficient values to determine a set of quantized coefficient values; and include, in a displacement sub-bitstream of the encoded dynamic mesh data, one or more syntax elements indicating the quantization parameter.

Clause 17. The device of clause 16, wherein to include, in the displacement sub-bitstream of the encoded dynamic mesh data, one or more syntax elements indicating the quantization parameter, the one or more processors are configured to include, in the displacement sub-bitstream of the encoded dynamic mesh data, a first syntax element indicating an initial value for the quantization parameter for a current frame.

Clause 18. The device of clause 17, wherein to include, in the displacement sub-bitstream of the encoded dynamic mesh data, one or more syntax elements indicating the quantization parameter, the one or more processors are further configured to include, in the encoded dynamic mesh data, a delta value indicating a difference between the initial value for the quantization parameter and a new quantization parameter.

Clause 19. The device of clause 17, wherein the first syntax element is included in a sequence parameter set of the displacement sub-bitstream.

Clause 20. The device of clause 16, wherein the one or more processors are configured to include parameters in the displacement sub-bitstream such that a video decoder inverse quantizes the set of quantized integer coefficient values to determine a set of fixed-point dequantized coefficient values without reference to any parameters included in a sub-bitstream other than the displacement sub-bitstream.

Clause 21. A method of decoding encoded mesh data, the method comprising: determining, based on the encoded mesh data, a base mesh; determining, using an inter prediction process, a set of coefficients; receiving in the encoded mesh data a quantization parameter value; determining an inverse scaling factor based on the quantization parameter value; performing an inverse scaling on the set of coefficients based on the inverse scaling factor to determine a set of de-quantized coefficients; determining a displacement vector based on the set of de-quantized coefficients; deforming the base mesh based on the displacement vector to determine a decoded mesh; and outputting the decoded mesh.

Clause 22. A device for decoding encoded mesh data, the device comprising: one or more memory units; and one or more processing units implemented in circuitry, coupled to the one or more memory units, and configured to perform the method of clause 21.

Clause 23. The device of clause 22, further comprising: a display configured to display the decoded mesh.

Clause 24. A device for decoding encoded dynamic mesh data, the device comprising: one or more memories; and one or more processors, implemented in circuitry and in communication with the one or more memories, configured to: determine a set of quantized integer coefficient values for displacement vectors of the encoded dynamic mesh data; determine a quantization parameter based on one or more syntax elements included in a displacement sub-bitstream of the encoded dynamic mesh data; inverse quantize, based on the quantization parameter, the set of quantized integer coefficient values to determine a set of fixed-point dequantized coefficient values; determine a set of fixed-point transformed coefficient values based on the set of fixed-point dequantized coefficient values; convert the set of fixed-point transformed coefficient values to a set of floating-point transformed coefficient values; inverse transform the set of floating-point transformed coefficient values to determine a set of reconstructed displacement vectors; and determine a reconstructed deformed mesh based on the set of reconstructed displacement vectors.

Clause 25. The device of clause 24, wherein to determine the quantization parameter based on the one or more syntax elements included in the displacement sub-bitstream of the encoded dynamic mesh data, the one or more processors are configured to: receive a first syntax element indicating an initial value for the quantization parameter for a first level of detail; and receive a second syntax element indicating a difference between the initial value for the quantization parameter and a new quantization parameter for a second level of detail.

Clause 26. The device of clause 25, wherein the first syntax element is included in a sequence parameter set of the displacement sub-bitstream.

Clause 27. The device of clause 24, wherein to determine the set of fixed-point transformed coefficient values based on the set of fixed-point dequantized coefficient values, the one or more processors are configured to add the set of fixed-point transformed coefficient values to a set of predicted transformed coefficient values.

Clause 28. The device of clause 24, wherein the one or more processors are configured to inverse quantize, based on the quantization parameter, the set of quantized integer coefficient values to determine the set of fixed-point dequantized coefficient values without reference to any parameters included in a sub-bitstream other than the displacement sub-bitstream.

Clause 29. The device of clause 24, wherein the one or more processors are further configured to: store the set of fixed-point transformed coefficient values in a reference buffer.

Clause 30. The device of clause 29, wherein the one or more processors are further configured to: determine a second set of quantized integer coefficient values; inverse quantize the second set of quantized integer coefficient values to determine a second set of fixed-point dequantized coefficient values; determine a second set of fixed-point transformed coefficient values based on the set of fixed-point dequantized coefficient values and the set of fixed-point transformed coefficient values stored in the reference buffer; convert the second set of fixed-point transformed coefficient values to a second set of floating-point transformed coefficient values; and inverse transform the second set of floating-point transformed coefficient values to determine a second set of reconstructed displacement vectors.

Clause 31. The device of clause 24, wherein to inverse transform the set of floating-point transformed coefficient values to determine the set of reconstructed displacement vectors, the one or more processors are further configured to apply an inverse wavelet transform to the set of floating-point transformed coefficient values.

Clause 32. The device of clause 24, wherein the one or more processors are further configured to modify a base mesh based on reconstructed displacement vectors to determine the reconstructed deformed mesh.

Clause 33. The device of clause 32, wherein the one or more processors are further configured to apply decoded attributes to the reconstructed deformed mesh to determine a reconstructed dynamic mesh sequence.34. A method for decoding encoded dynamic mesh data, the method comprising: determining a set of quantized integer coefficient values for displacement vectors of the encoded dynamic mesh data; determining a quantization parameter based on one or more syntax elements included in a displacement sub-bitstream of the encoded dynamic mesh data; inverse quantizing, based on the quantization parameter, the set of quantized integer coefficient values to determine a set of fixed-point dequantized coefficient values; determining a set of fixed-point transformed coefficient values based on the set of fixed-point dequantized coefficient values; converting the set of fixed-point transformed coefficient values to a set of floating-point transformed coefficient values; inverse transforming the set of floating-point transformed coefficient values to determine a set of reconstructed displacement vectors; and determining a reconstructed deformed mesh based on the set of reconstructed displacement vectors.

Clause 35. The method of clause 34, wherein determining the quantization parameter based on the one or more syntax elements included in the displacement sub-bitstream of the encoded dynamic mesh data comprises receiving a first syntax element indicating an initial value for the quantization parameter for a current frame.

Clause 36. The method of clause 35, wherein determining the quantization parameter based on the one or more syntax elements included in the displacement sub-bitstream of the encoded dynamic mesh data comprises receiving a delta value indicating a difference between the initial value for the quantization parameter and a new quantization parameter.

Clause 37. The method of clause 35, wherein the first syntax element is included in a sequence parameter set of the displacement sub-bitstream.

Clause 38. The method of clause 34, further comprising inverse quantizing, based on the quantization parameter, the set of quantized integer coefficient values to determine the set of fixed-point dequantized coefficient values without reference to any parameters included in a sub-bitstream other than the displacement sub-bitstream.39. A device for encoding dynamic mesh data, the device comprising: one or more memories; and one or more processors, implemented in circuitry and in communication with the one or more memories, configured to: determine a set of integer coefficient values for displacement vectors of the encoded dynamic mesh data; determine a quantization parameter; quantize, based on the quantization parameter, the set of integer coefficient values to determine a set of quantized coefficient values; and include, in a displacement sub-bitstream of the encoded dynamic mesh data, one or more syntax elements indicating the quantization parameter.

Clause 40. The device of clause 39, wherein to include, in the displacement sub-bitstream of the encoded dynamic mesh data, one or more syntax elements indicating the quantization parameter, the one or more processors are configured to include, in the displacement sub-bitstream of the encoded dynamic mesh data, a first syntax element indicating an initial value for the quantization parameter for a current frame.

Clause 41. The device of clause 40, wherein to include, in the displacement sub-bitstream of the encoded dynamic mesh data, one or more syntax elements indicating the quantization parameter, the one or more processors are further configured to include, in the encoded dynamic mesh data, a delta value indicating a difference between the initial value for the quantization parameter and a new quantization parameter.

Clause 42. The device of clause 40, wherein the first syntax element is included in a sequence parameter set of the displacement sub-bitstream.

Clause 43. The device of clause 39, wherein the one or more processors are configured to include parameters in the displacement sub-bitstream such that a video decoder inverse quantizes the set of quantized integer coefficient values to determine a set of fixed-point dequantized coefficient values without reference to any parameters included in a sub-bitstream other than the displacement sub-bitstream.

Clause 44. A method for encoding dynamic mesh data, the method comprising: determining a set of integer coefficient values for displacement vectors of the encoded dynamic mesh data; determining a quantization parameter; quantizing, based on the quantization parameter, the set of integer coefficient values to determine a set of quantized coefficient values; and including, in a displacement sub-bitstream of the encoded dynamic mesh data, one or more syntax elements indicating the quantization parameter.

Clause 45. The method of clause 44, wherein including, in the displacement sub-bitstream of the encoded dynamic mesh data, one or more syntax elements indicating the quantization parameter comprises including, in the displacement sub-bitstream of the encoded dynamic mesh data, a first syntax element indicating an initial value for the quantization parameter for a current frame.

Clause 46. The method of clause 45, wherein including, in the displacement sub-bitstream of the encoded dynamic mesh data, one or more syntax elements indicating the quantization parameter comprises including, in the encoded dynamic mesh data, a delta value indicating a difference between the initial value for the quantization parameter and a new quantization parameter.

Clause 47. The method of clause 45, wherein the first syntax element is included in a sequence parameter set of the displacement sub-bitstream.

Clause 48. The method of clause 44, further comprising: including parameters in the displacement sub-bitstream such that a video decoder inverse quantizes the set of quantized integer coefficient values to determine a set of fixed-point dequantized coefficient values without reference to any parameters included in a sub-bitstream other than the displacement sub-bitstream.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for decoding encoded dynamic mesh data, the device comprising:
one or more memories; and
one or more processors, implemented in circuitry and in communication with the one or more memories, configured to:
determine a set of quantized integer coefficient values for displacement vectors of the encoded dynamic mesh data;
determine a quantization parameter based on one or more syntax elements included in a displacement sub-bitstream of the encoded dynamic mesh data;
inverse quantize, based on the quantization parameter, the set of quantized integer coefficient values to determine a set of fixed-point dequantized coefficient values;
determine a set of fixed-point transformed coefficient values based on the set of fixed-point dequantized coefficient values;
convert the set of fixed-point transformed coefficient values to a set of floating-point transformed coefficient values;
inverse transform the set of floating-point transformed coefficient values to determine a set of reconstructed displacement vectors; and
determine a reconstructed deformed mesh based on the set of reconstructed displacement vectors.

2. The device of claim 1, wherein to determine the quantization parameter based on the one or more syntax elements included in the displacement sub-bitstream of the encoded dynamic mesh data, the one or more processors are configured to:
receive a first syntax element indicating an initial value for the quantization parameter for a first level of detail; and
receive a second syntax element indicating a difference between the initial value for the quantization parameter and a new quantization parameter for a second level of detail.

3. The device of claim 2, wherein the first syntax element is included in a sequence parameter set of the displacement sub-bitstream.

4. The device of claim 1, wherein to determine the set of fixed-point transformed coefficient values based on the set of fixed-point dequantized coefficient values, the one or more processors are configured to add the set of fixed-point transformed coefficient values to a set of predicted transformed coefficient values.

5. The device of claim 1, wherein the one or more processors are configured to inverse quantize, based on the quantization parameter, the set of quantized integer coefficient values to determine the set of fixed-point dequantized coefficient values without reference to any parameters included in a sub-bitstream other than the displacement sub-bitstream.

6. The device of claim 1, wherein the one or more processors are further configured to:
store the set of fixed-point transformed coefficient values in a reference buffer.

7. The device of claim 6, wherein the one or more processors are further configured to:
determine a second set of quantized integer coefficient values;
inverse quantize the second set of quantized integer coefficient values to determine a second set of fixed-point dequantized coefficient values;
determine a second set of fixed-point transformed coefficient values based on the set of fixed-point dequantized coefficient values and the set of fixed-point transformed coefficient values stored in the reference buffer;
convert the second set of fixed-point transformed coefficient values to a second set of floating-point transformed coefficient values; and
inverse transform the second set of floating-point transformed coefficient values to determine a second set of reconstructed displacement vectors.

8. The device of claim 1, wherein to inverse transform the set of floating-point transformed coefficient values to determine the set of reconstructed displacement vectors, the one or more processors are further configured to apply an inverse wavelet transform to the set of floating-point transformed coefficient values.

9. The device of claim 1, wherein the one or more processors are further configured to modify a base mesh based on reconstructed displacement vectors to determine the reconstructed deformed mesh.

10. The device of claim 9, wherein the one or more processors are further configured to apply decoded attributes to the reconstructed deformed mesh to determine a reconstructed dynamic mesh sequence.

11. A method for decoding encoded dynamic mesh data, the method comprising:
determining a set of quantized integer coefficient values for displacement vectors of the encoded dynamic mesh data;
determining a quantization parameter based on one or more syntax elements included in a displacement sub-bitstream of the encoded dynamic mesh data;
inverse quantizing, based on the quantization parameter, the set of quantized integer coefficient values to determine a set of fixed-point dequantized coefficient values;
determining a set of fixed-point transformed coefficient values based on the set of fixed-point dequantized coefficient values;
converting the set of fixed-point transformed coefficient values to a set of floating-point transformed coefficient values;
inverse transforming the set of floating-point transformed coefficient values to determine a set of reconstructed displacement vectors; and
determining a reconstructed deformed mesh based on the set of reconstructed displacement vectors.

12. The method of claim 11, wherein determining the quantization parameter based on the one or more syntax elements included in the displacement sub-bitstream of the encoded dynamic mesh data comprises receiving a first syntax element indicating an initial value for the quantization parameter for a current frame.

13. The method of claim 12, wherein determining the quantization parameter based on the one or more syntax elements included in the displacement sub-bitstream of the encoded dynamic mesh data comprises receiving a delta value indicating a difference between the initial value for the quantization parameter and a new quantization parameter.

14. The method of claim 12, wherein the first syntax element is included in a sequence parameter set of the displacement sub-bitstream.

15. The method of claim 11, further comprising inverse quantizing, based on the quantization parameter, the set of quantized integer coefficient values to determine the set of fixed-point dequantized coefficient values without reference to any parameters included in a sub-bitstream other than the displacement sub-bitstream.

16. A device for encoding dynamic mesh data, the device comprising:
one or more memories; and
one or more processors, implemented in circuitry and in communication with the one or more memories, configured to:
determine a set of integer coefficient values for displacement vectors of the encoded dynamic mesh data;
determine a quantization parameter;
quantize, based on the quantization parameter, the set of integer coefficient values to determine a set of quantized coefficient values; and
include, in a displacement sub-bitstream of the encoded dynamic mesh data, one or more syntax elements indicating the quantization parameter.

17. The device of claim 16, wherein to include, in the displacement sub-bitstream of the encoded dynamic mesh data, one or more syntax elements indicating the quantization parameter, the one or more processors are configured to include, in the displacement sub-bitstream of the encoded dynamic mesh data, a first syntax element indicating an initial value for the quantization parameter for a current frame.

18. The device of claim 17, wherein to include, in the displacement sub-bitstream of the encoded dynamic mesh data, one or more syntax elements indicating the quantization parameter, the one or more processors are further configured to include, in the encoded dynamic mesh data, a delta value indicating a difference between the initial value for the quantization parameter and a new quantization parameter.

19. The device of claim 17, wherein the first syntax element is included in a sequence parameter set of the displacement sub-bitstream.

20. The device of claim 16, wherein the one or more processors are configured to include parameters in the displacement sub-bitstream such that a video decoder inverse quantizes the set of quantized integer coefficient values to determine a set of fixed-point dequantized coefficient values without reference to any parameters included in a sub-bitstream other than the displacement sub-bitstream.
